(19) United States
(12) Patent Application Publication
(10) Pub. No.: US 2025/0217028 A1
(43) Pub. Date: Jul. 3, 2025

(54) INTERACTIVE WHITEBOARD USING ARTIFICIAL INTELLIGENCE

(71) Applicant: Google LLC, Mountain View, CA (US)

(72) Inventors: Kolati Mallikarjuna Rao, San Diego, CA (US); Bhavik Patel, San Diego, CA (US); Harikrishna Mallisetty, San Diego, CA (US)

(21) Appl. No.: 18/399,151

(22) Filed: Dec. 28, 2023

(51) Int. Cl. G06F 3/04883; G06F 3/0481; G06F 3/16; G06F 16/9532; G06V 30/19; G06V 30/32

(52) U.S. Cl. CPC G06F 3/04883; G06F 3/0481; G06F 3/167; G06F 16/9532; G06V 30/191; G06V 30/32

(57) ABSTRACT

Implementations utilize an AI-powered whiteboard to enhance communications and collaborations. A user can provide a handwritten input via a whiteboard user interface, and one or more machine learning models can be utilized to recognize and interpret the handwritten input, to generate whiteboard content that is responsive to the handwritten input and that is to be rendered within the whiteboard user interface with respect to the handwritten input. The handwritten input can include a handwritten text string and/or a hand-drawn sketch. The whiteboard content can be tailored based on a user profile, audible input, and/or control input.

### BACKGROUND

A whiteboard is a common tool used in classrooms, meetings, or other settings, to facilitate communication and collaboration. However, traditional whiteboards have several limitations. For example, they can be difficult to use for completing complex tasks which can involve solving equations or drawing diagrams. As another example, traditional whiteboards provide neither immediate feedback nor additional or supplemental information.

### SUMMARY

Implementations disclosed herein are directed to artificial intelligence enabled methods and systems for facilitating communications and collaborations in classrooms, meetings, and/or other settings. In various implementations, a whiteboard content generation model is provided, where the whiteboard content generation model is trained to recognize and interpret a handwritten input. In some implementations, the handwritten input can include a handwritten text string and/or a hand-drawn sketch (corresponding to an object, diagram, formula, etc.). In these implementations, an image containing the handwritten text string and/or the hand-drawn sketch can be acquired and pre-processed, and the whiteboard content generation model can be trained to recognize the handwritten text string and/or the hand-drawn sketch from the pre-processed image that contains the handwritten text string and/or the hand-drawn sketch. For example, in some implementations, the whiteboard content generation model may be a generative machine learning model that may or may not be transformer based, such as a visual question answering (VQA) model, or other types of large language models (LLMs) such as PaLM, BERT, LaMDA, Meena, and/or any other LLM/VQA model, such as any other model that is encoder-only based, decoder-only based, sequence-to-sequence based and that optionally includes an attention mechanism or other memory. These generative models may include hundreds of millions, billions, tens of billions, or even hundreds of billions of parameters.

In some implementations, the whiteboard content generation model can be trained to generate a model output based on the handwritten input (e.g., based on processing the aforementioned image containing the handwritten text string and/or the hand-drawn sketch, or based on processing data indicative of such image). The model output can be processed to determine whiteboard content (e.g., text, video, diagram, feedback, and/or additional information, sometimes referred to as “additional whiteboard content” in case the handwritten input rendered is referred to as “whiteboard content”) to be rendered in response to the handwritten input.

As a non-limiting working example, a user may provide a handwritten word of “cat” (or other handwritten text string) to a whiteboard user interface of a client device, using a finger or a stylus pen. The whiteboard user interface can be displayed via a touch panel of the client device, and/or can be provided by a whiteboard application installed at, or accessible via, the client device. An image containing the handwritten word of “cat” can be pre-processed (e.g., to remove noise and/or to re-size, etc.), and the pre-processed image that contains the handwritten word of “cat” can be processed using the whiteboard content generation model, to generate model output. Based on the model output of the whiteboard content generation model, whiteboard content responsive to the handwritten input (e.g., the handwritten word of “cat”) can be determined/generated. For instance, in some implementations, the whiteboard content determined based on the model output can include an image depicting a cat. Alternatively or additionally, a description for cat can be generated based on the model output. Alternatively or additionally, the whiteboard content determined based on the model output can include additional information (e.g., syllables for the word “cat”, and/or a list of pairing words for the word “cat”, such as “bat”, “hat”, and “mat”) that supplements the description for cat. Alternatively or additionally, the whiteboard content determined based on the model output can include a video showing how to pronounce the word “cat”.

Continuing with the above non-limiting working example, in some implementations, the whiteboard content can be determined based on a user profile of the user (e.g., based on age (or a range of ages), education, hobby, occupation, etc., which are indicated by or included in the user profile of the user). For instance, the user may have a registered account of the whiteboard application, and may have created a user profile in association with the registered account of the whiteboard application. In this case, the whiteboard content can be determined based on the user profile that is in association with the registered account of the whiteboard application. This way, different whiteboard content can be presented to different users that have different ages, occupations, etc. (according to the user profile), even when the different users provide handwritten input (e.g., at the whiteboard user interface of the whiteboard application) convertible into the same typed input or object.

Continuing with the above non-limiting working example, in some implementations, the whiteboard content determined based on the model output can be rendered at a location of the whiteboard user interface with respect to the handwritten input of the user (e.g., the handwritten word of “cat”). For instance, the whiteboard content can be rendered at a non-overlapping location with respect to the handwritten input. In some implementations, the user may be able to modify the location (and/or a size) of the whiteboard content that is rendered within the whiteboard user interface. For example, the user may be able to move the whiteboard content from a right corner of the whiteboard user interface (assume the right corner is the original rendering location of the whiteboard content) to a bottom area of the whiteboard user interface.

Continuing with the above non-limiting working example, in some implementations, different types of the whiteboard content can be rendered simultaneously or in a certain order. In some implementations, the different types of the whiteboard content can be rendered separately with respect to the handwritten input (e.g., the handwritten word of “cat”). For instance, the aforementioned image that depicts a cat (which is included in the whiteboard content) can be rendered at a first location with respect to the handwritten input of “cat”, and a short description for cat (which is also included in the whiteboard content) can be rendered at a second location (different from the first location) with respect to the handwritten input of “cat”. In this case, the image that depicts a cat can be moved around by the user (using a first hand gesture received via the whiteboard user interface, such as touch-drag-and-release of at least a portion of the handwritten input using a single finger) within the whiteboard user interface, and the short description for cat can also be moved around by the user within the whiteboard user interface. Optionally, the handwritten input may also be moved around by the user within the whiteboard user interface. The handwritten input and/or the whiteboard content are configured to be movable, for instance, in order to save space for additional handwritten input from the user or from other user(s) as collaboration or communication continues.

In some implementations, the whiteboard content (or a portion thereof) can be removed from the whiteboard user interface after being rendered. For instance, the short description for cat can be removed or erased from the whiteboard user interface by the user using a second hand gesture (which is received at the whiteboard user interface, the second hand gesture being different from the first hand gesture) within a region (e.g., a “bounding box” generated based on the model output) of the whiteboard user interface that encloses the short description, while the image that depicts a cat remains being rendered at the whiteboard user interface.

In some implementations, optionally, the whiteboard content generation model can include an image encoder that encodes the aforementioned pre-processed image that contains the handwritten input. The image encoder, for instance, can generate a latent representation (e.g., a N-dimensional vector) that represents the pre-processed image (which contains the handwritten text or sketch) in a latent space. The image encoder, for instance, can include one or more convolutional neural networks.

In some implementations, optionally, the whiteboard content generation model can further include a text encoder that encodes raw text strings (e.g. text strings predicted from user handwritten/drawn input) into the aforementioned latent space. The text encoder and the aforementioned image encoder may be trained simultaneously to associate handwritten text strings with corresponding raw text strings. Additionally and/or alternatively, the text encoder and the image encoder may be trained simultaneously to associate hand-drawn sketches (that correspond to objects, diagrams, formulas, equations, etc.) with corresponding raw text strings. In some implementations, the text encoder and the image encoder can be trained (or can be fine-tuned if the image and text encoders have already been trained) using multiple image-text pairs, where each image-text pair includes an image capturing a handwritten text string (or a hand-drawn sketch) and a raw text string (sometimes referred to as “label” or “textual label”, etc.) that corresponds (or describes) the handwritten text string (or the hand-drawn sketch) in the image.

In some implementations, optionally, the whiteboard content generation model can further include a text decoder configured to generate a raw text string based on the latent representation (e.g., the aforementioned N-dimensional vector) that represents the pre-processed image (which contains the handwritten text or sketch). The raw text string (e.g., typed word of “cat”) may be processed to generate a textual prompt, where the textual prompt can be processed using a transformer, to generate the aforementioned model output. The textual prompt can be or can include, for instance, a default instruction/request to generate certain whiteboard content (e.g., an image, a video, and/or a short description, etc.) for the typed word of “cat” which is derived from the handwritten word of “cat”. As a non-limiting example, the textual prompt (in natural language) can be: “generate an image and a short description for the following: cat”. In some implementations, the transformer can include an encoder portion and a decoder portion, where the encoder portion encodes the aforementioned raw text string and the decoder portion is utilized to generate the natural language content, image, and/or video based on the encoded raw text string. The transformer can be or can include, for instance, one or more transformer neural networks. The transformer can be, for instance, a generative model used to process natural language (NL) content and/or other input(s), to generate output that reflects generative content that is responsive to the input(s).

In some implementations, the textual prompt can be modified based on additional user input(s) (if any). For instance, the user may have selected a control (e.g., a selectable graphical user interface “GUI” element) at the whiteboard user interface that limits the whiteboard content to be of a particular type (e.g., image, short description, video, etc.). In this case, the default instruction/request can be modified into a modified instruction/request that is to generate the whiteboard content that is of the particular type and that is responsive to the typed word of “cat”. The modified instruction (and/or the raw text string which is determined based on the handwritten text string/word of “cat”) can be processed using the transformer, to determine a model output from which whiteboard content of the particular type can be determined. The determined whiteboard content of the particular type can then be rendered at the whiteboard user interface, with respect to the handwritten text string (or hand-drawn sketch).

In some other implementations, the whiteboard content generation model can include a different architecture than that described above. For example, the whiteboard content generation model may include a single encoder and a single decoder, where the single encoder encodes the aforementioned pre-processed image of handwritten text string (or hand-drawn sketch), and the single decoder decodes the encoded preprocessed image, to generate the whiteboard content that is to be rendered responsive to the handwritten text string (or sketch).

As another example, the whiteboard content generation model may include a handwriting recognition model for recognizing the handwriting text string or hand-drawn sketch (may be also referred to as “hand-drawn sketch”). In some implementations, optionally, the whiteboard content generation model (or the handwriting recognition model) may utilize handwriting data that is collected in association with the handwritten text string (or hand-drawn sketch). The handwriting data, for instance, can include stroke information and/or trajectory information associated with the handwritten text string (or hand-drawn sketch). The stroke information can include or indicate a sequence of strokes, where each stroke in the sequence can correspond to a sequence of adjoining points each having a position defined in a coordinate system (e.g., a two-dimensional coordinate system). The trajectory information can include or indicate an order of strokes in the sequence of strokes and/or an order of one or more points in a stroke. The stroke information and/or the trajectory information may be received, for instance, via a stylus pen.

In some other implementations, alternatively or additionally, the whiteboard content generation model (or the handwriting recognition model) may utilize audio input and/or typed input in a context associated with the handwritten text string (or sketch). For instance, in a classroom setting, a user may provide an utterance of “cat” while, before, or after writing down a handwritten word of “cat” (i.e., the aforementioned handwritten text string) at the whiteboard user interface. In this case, a transcription of the user utterance can be determined and be provided to a whiteboard content generation engine that operates the whiteboard content generation model, to be processed using the whiteboard content generation model.

In various implementations, a method implemented using one or more processors is provided. The method includes receiving a user input via a whiteboard user interface of a computing device, the user input being a handwritten text string or a hand-drawn sketch. The user input can be displayed in real-time at the whiteboard user interface. Optionally, the user input can remain displayed if not erased by a user that provides the user input (or other user(s)).

In various implementations, the method further includes: processing an image containing the handwritten text string or the hand-drawn sketch, using a trained machine learning model, to generate a model output from which whiteboard content responsive to the user input is determined. In some implementations, the image containing the handwritten text string or the hand-drawn sketch can be, for instance, a pre-processed image acquired based on pre-processing a screenshot of the whiteboard user interface that encloses the handwritten text string or the hand-drawn sketch. Pre-processing, for instance, can remove background noise from the screenshot, and/or can resize the screenshot so that the pre-processed image is of a predetermined size.

In some implementations, the model output can include or indicate an image (and/or a video) responsive to the user input. In some other implementations, the model output can include an image tag (and/or a video tag) using which an image or a video (e.g., depicting a cat) for the handwritten text string (e.g., handwritten word of “cat”) can be retrieved. In these implementations, the whiteboard content includes an image or a video responsive to the user input. Alternatively or additionally, the whiteboard content includes a natural language description (e.g., a short description introducing “cat”) generated based on the user input (e.g., handwritten word of “cat” or a hand-drawn sketch of “cat”), or other types of content responsive to the user input.

Put another way, the whiteboard content can include a single type of content, or can include content of different types. The content of different types can be rendered within the whiteboard user interface at different locations. Alternatively or additionally, the content of different types can be rendered within the whiteboard user interface, simultaneously or in a certain order. For example, the whiteboard content can include: content of a first type, and content of a second type. The second type is different from the first type. In this case, the content of the first type can be displayed at a first location within the whiteboard user interface with respect to the handwritten text string (or hand-drawn sketch). The content of the second type can be displayed at a second location within the whiteboard user interface with respect to the user input (handwritten text string or hand-drawn sketch that is rendered at the whiteboard user interface), where the second location is different from the first location. In some implementations, the content of the second type is rendered at the second location in a non-overlapping manner with respect to the content of the first type and with respect to the user input, and the content of the first type is rendered at the first location in a non-overlapping manner with respect to the user input.

Optionally, the model output can indicate or include a bounding box for the whiteboard content (when having a single type of content). Optionally, the model output can indicate or include multiple bounding boxes respectively for the different types of content (e.g., image, video, URL link, natural language description, etc.) that are included in the whiteboard content. In some implementations, the bounding box (or each of the multiple bounding boxes) can be moved around within the whiteboard user interface pursuant to additional user input (e.g., a drag gesture) received within the bounding box that is rendered at the whiteboard user interface. For example, the aforementioned content of the first type displayed at the first location can be enclosed by a first bounding box, and the content of the second type displayed at the second location can be enclosed by a second bounding box. In this example, a user may drag the first bounding box (e.g., using two fingers, etc.) to change a location where the content of the first type is rendered from the first location to a third location. The user (or a different user) may drag the second bounding box (e.g., using two fingers, etc.) to change a location where the content of the first type is rendered from the second location to a fourth location. The user (or a different user) may even drag (or use another gesture) the user input (handwritten text string or the hand-drawn sketch) to change a location where the user input is rendered.

In some implementations, the trained machine learning model includes an image encoder configured to encode an image capturing the user input (the handwritten text string or the hand-drawn sketch) at the whiteboard user interface, into an image embedding for the user input (handwritten text string or the hand-drawn sketch) in a latent space. The image encoder for instance, can include one or more neural networks. In these implementations, the trained machine learning model includes a text decoder configured to decode the image embedding in the latent space into a raw text string, and the trained machine learning model can include a transformer to generate the whiteboard content based on processing the raw text string.

In some implementations, the user input includes a mathematical question. In these implementations, the whiteboard content includes a solution to the mathematical question.

In some implementations, the trained machine learning model is local to the computing device (e.g., an electronic whiteboard device). The electronic whiteboard device, for instance, can be a portable electronic whiteboard. In some other implementations, the trained machine learning model is at a server device that is remote to the computing device.

In various implementations, the method further includes: causing the whiteboard content responsive to the user input to be rendered at the whiteboard user interface in a location relative to the user input.

The preceding is presented as an overview of only some implementations disclosed herein. These and other implementations are disclosed in additional detail herein. For example, additional and/or alternative implementations are disclosed herein such as those directed to rendering the whiteboard content in a same or similar style (font and/or size) of the handwritten text string (or handwritten sketch) that is included in the user input.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B illustrates an example of rendering a response that demonstrates various aspects of the present disclosure, and in which some implementations disclosed herein can be implemented.

FIG. 1C illustrates an example of rendering a response that demonstrates various aspects of the present disclosure, and in which some implementations disclosed herein can be implemented.

FIG. 2A, FIG. 2B, FIG. 2C and FIG. 2D depicts a first scenario, in accordance with various aspects of the present disclosure.

FIG. 3A, FIG. 3B, and FIG. 3C depict a second scenario, in accordance with various aspects of the present disclosure.

FIG. 3A, FIG. 3B and FIG. 3D depict a third scenario, in accordance with various aspects of the present disclosure.

FIG. 3A, FIG. 3B, and FIG. 3E depict a fourth scenario, in accordance with various aspects of the present disclosure.

FIG. 3A, FIG. 3B and FIG. 3F depict a fifth scenario, in accordance with various aspects of the present disclosure.

FIG. 3A, FIG. 3B, and FIG. 3G depict a sixth scenario, in accordance with various aspects of the present disclosure.

FIG. 3A, FIG. 3B, and FIG. 3H depict a seventh scenario, in accordance with various aspects of the present disclosure.

FIG. 4 depicts a flowchart illustrating an example method of generating content responsive to handwritten input, in accordance with various aspects of the present disclosure.

FIG. 5 depicts an example architecture of a computing device, in accordance with various implementations.

FIG. 6A, FIG. 6B, FIG. 6C, FIG. 6D, FIG. 6E, and FIG. 6F depict an additional scenario, in accordance with various aspects of the present disclosure.

FIG. 7 depicts a flowchart illustrating another example method of generating content responsive to handwritten input, in accordance with various aspects of the present disclosure.

### DETAILED DESCRIPTION

The following description with reference to the accompanying drawings is provided for understanding of various implementations of the present disclosure. It's appreciated that different features from different embodiments may be combined with and/or exchanged for one another. In addition, those of ordinary skill in the art will recognize that various changes and modifications of the various embodiments described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

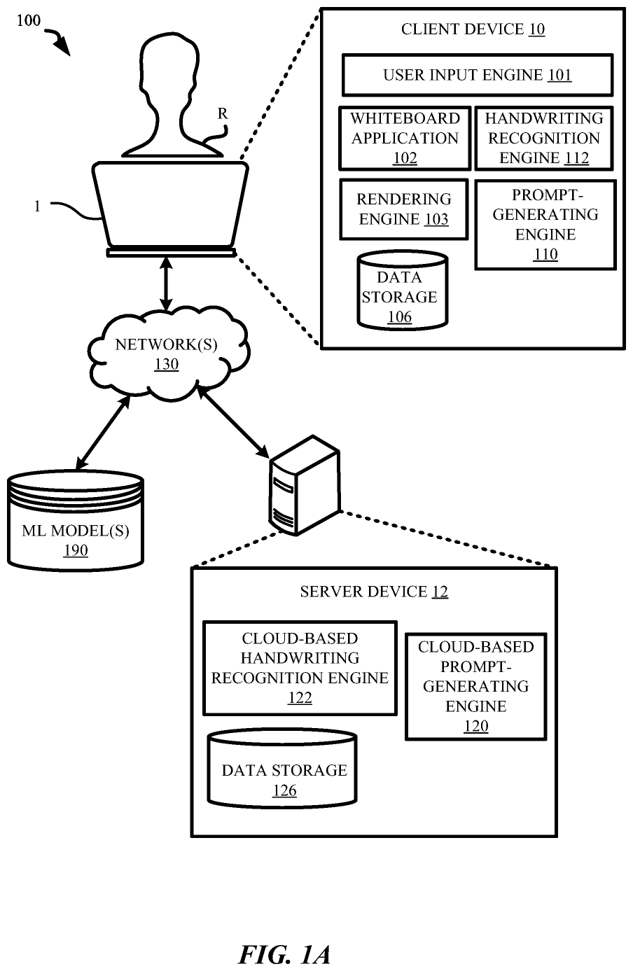

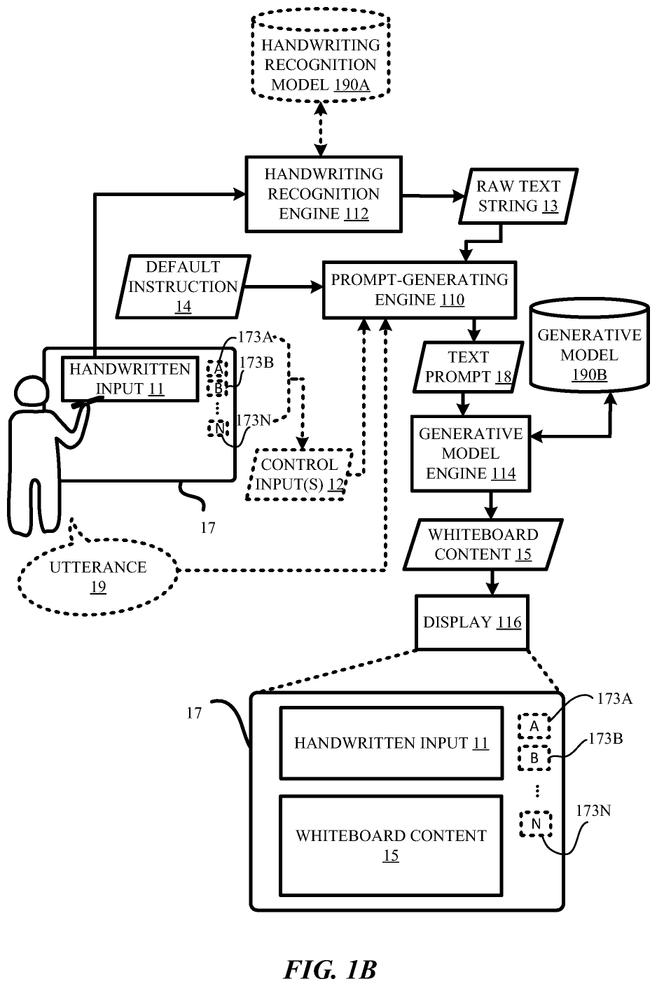

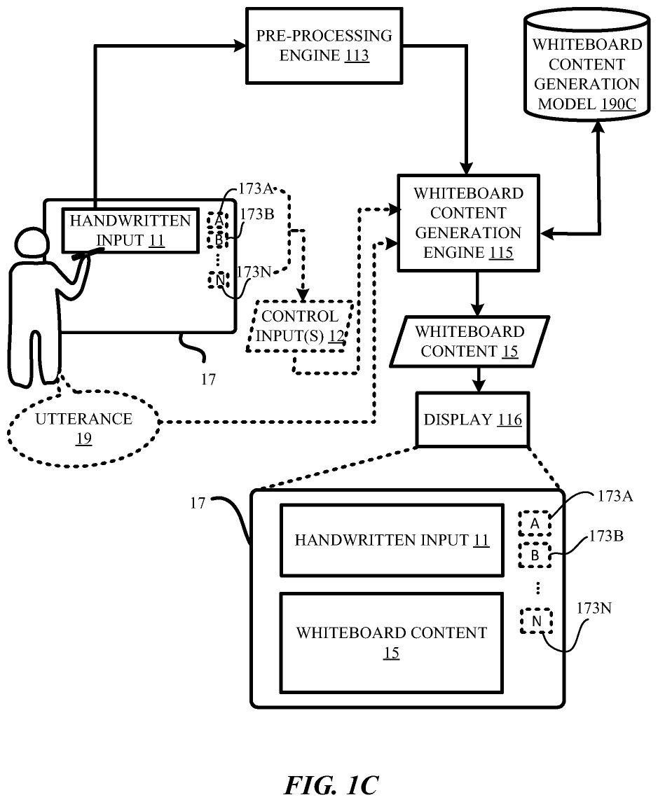

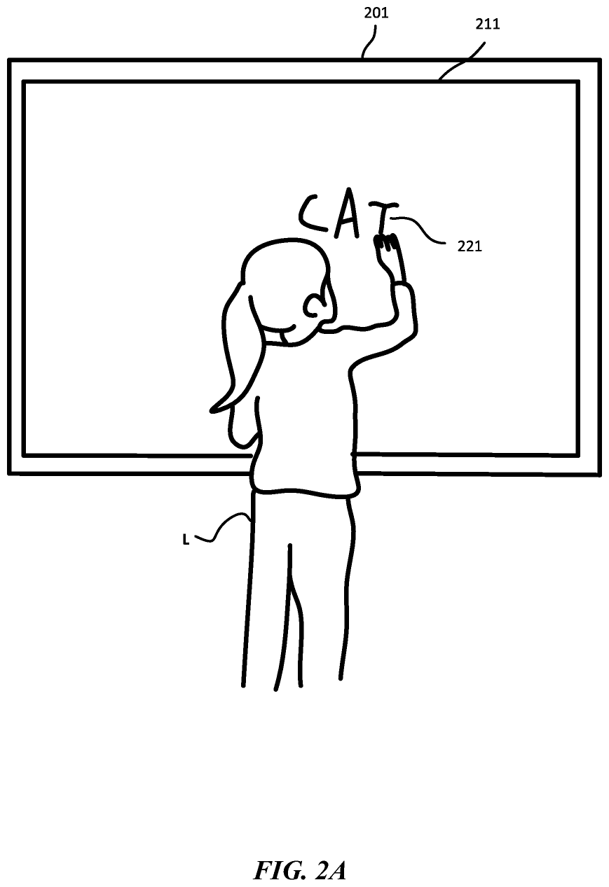

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) in communication with the client computing device 10 via one or more networks 130. The one or more networks 130 can include, for example, a local area network (LAN), a wide area network (WAN) such as the Internet, and/or any other appropriate network.

The client computing device 10 can be, but does not necessarily need to be, a portable device. The client computing device 10, for instance, can be an electronic whiteboard, or other applicable device having a touch display, such as a smartphone. In some implementations, client computing device 10 may be a projector, and handwritten user input may be detected, for instance, using a camera that is pointed at the surface (e.g., screen) on which the projector is projecting. In various implementations, the client computing device 10 can include a user input engine 101 that is configured to detect user input provided by a user of the client computing device 10 using one or more user interface input devices. For example, the client computing device 10 can include a touch panel as a user interface input device to capture signal(s) corresponding to user input directed to the client computing device 10. The user input directed to the touch panel can be a touch input received by the client computing device 10 at the touch panel, where the touch input can be or can include a handwritten text string (or a hand-drawn sketch). For instance, the user can use a finger or a stylus to provide a handwritten word of “cat” to the client computing device 10 via the touch panel. As another example, the user can provide a hand-drawn sketch, such as a line drawing of a house, a mathematical equation, a chemical formula, etc.

Additionally, or alternatively, the client computing device 10 can be equipped with a keyboard and mouse as user interface input devices to receive typed input from the user. Additionally, or alternatively, the client computing device 10 can be equipped with one or more hardware buttons as user interface input devices to receive user selection of a function enabled by a corresponding hardware button of the one or more hardware buttons.

Additionally, or alternatively, the client computing device 10 can be equipped with one or more microphones as user interface input devices to receive audible input from the user, such as audio data capturing spoken utterance(s) of the user. The one or more microphones may also capture other audio data, such as a sound in an environment of the client computing device 10.

Additionally, or alternatively, the client computing device 10 can be equipped with one or more vision components (e.g., camera) that are configured to capture vision data associated with the user, such as a movement and/or a gesture of the user. The vision data captured using the one or more vision components can also include one or more objects detected in a field of view of one or more of the vision components.

In some implementations, a query can be formulated based on the touch input (e.g., the handwritten text string or the hand-drawn sketch) from the user, a typed input from the user, a transcription of spoken utterances from the user, and/or the vision data.

In various implementations, the client computing device 10 can include a rendering engine 103, and/or a data storage 106. The data storage 106, for instance, can be configured to store a user profile in association with the client computing device 10, or other user data, files, etc. In various implementations, the rendering engine 103 can be configured to display, for instance, the touch input from the user. For instance, the user may be using the finger or the stylus to provide the aforementioned handwritten word of “cat” to the client computing device 10 via a whiteboard user interface displayed via the touch panel. In this case, the touch input can be rendered visually by the rendering engine 103 at the whiteboard user interface in real-time.

In various implementations, the rendering engine 103 can be configured to provide content for audible and/or visual presentation to the user of the client computing device 10 using one or more user interface output devices. For example, the touch panel may function as a user interface output device at which content responsive to the user input can be rendered. Additionally, or alternatively, the client computing device 10 can be equipped with one or more speakers that enable content to be provided for audible presentation to the user via the client computing device 10.

In various implementations, the client computing device 10 can further include a plurality of components. The plurality of local components can include an automatic speech recognition (ASR) engine (not illustrated) and/or a text-to-speech (TTS) engine (not illustrated). In various implementations, the client computing device 10 can further include one or more applications installed at the client computing device 10. In some implementations, the one or more applications can include an automated assistant (may also be known as “chatbot”, “interactive assistant”, etc.) as a primary application, and the ASR engine and/or the TTS engine may be included in the automated assistant. In some implementations, the automated assistant can further include additional component(s), such as a NLU engine and/or a fulfillment engine. In some implementations, the one or more applications can include one or more third-party applications, and a user (e.g., user R) of the client computing device 10 may have a registered account associated with the automated assistant and/or the one or more third-party applications. The one or more third-party applications can include, for example, a whiteboard application 102 (standalone or web-based) that provides access to the aforementioned whiteboard user interface. Alternatively or additionally, the one or more third-party applications can include a social media application, a video player, a note-taking application, a shopping application, a messaging application, and/or any other appropriate applications (or services), and the present disclosure is not limited thereto.

In various implementations, the server computing device 12 can be, for example, a web server, a blade server, or any other type of server as needed. In various implementations, the server computing device 12 can include cloud-based components the same as or similar to the plurality of local components installed at the client computing device 1. For example, the server computing device 12 can include a cloud-based ASR engine, a cloud-based TTS engine, a cloud-based NLU engine, and/or a cloud-based fulfillment engine.

The ASR engine (and/or the cloud-based ASR engine) can process, using one or more streaming ASR models (e.g., a recurrent neural network (RNN) model, a transformer model, and/or any other type of ML model capable of performing ASR), streams of audio data that capture spoken utterances and that are generated by microphone(s) of the client computing device 10 to generate corresponding streams of ASR output. Notably, the streaming ASR model can be utilized to generate the corresponding streams of ASR output as the streams of audio data are generated. Based on the corresponding streams of ASR output, a speech recognition (“a text transcript”) of the spoken utterances can be determined.

In various implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine can select one or more of the ASR hypotheses as corresponding recognized text that corresponds to the spoken utterance(s) (e.g., selected based on the corresponding predicted measures).

In various implementations, the TTS engine can process, using TTS model(s), textual content (e.g., generated using the automated assistant or other components of the client computing device 10), to generate synthesized speech audio data that includes computer-generated synthesized speech for the textual content.

In some implementations, the NLU engine and/or the cloud-based NLU engine can process, using one or more NLU models (e.g., a long short-term memory (LSTM), gated recurrent unit (GRU), and/or any other type of RNN or other ML model capable of performing NLU) and/or grammar-based rule(s), the corresponding streams of ASR output to generate corresponding streams of NLU output. The fulfillment engine and/or the cloud-based fulfillment engine can cause the corresponding streams of NLU output to be processed to generate corresponding streams of fulfillment data. The corresponding streams of fulfillment data can be utilized, for instance, to control a smart device in communication with the automated assistant. The aforementioned ML model(s) 190 can be on-device ML models that are stored locally at the client computing device 10, remote ML models that are executed remotely from the server computing device (e.g., at remote server device 12), or shared ML models that are accessible to both the client computing device 10 and/or remote systems (e.g., the remote server computing device 12).

In various implementations, the plurality of local components of the client computing device 10 can include a handwriting recognition engine 112 and/or a prompt-generating engine 110. The handwriting recognition engine 112 (and/or its cloud-based counterpart, e.g., a cloud-based handwriting recognition engine 122 which is accessible at the server device 12 and has the same or similar functions as the handwriting recognition engine 112) may be configured to recognize a handwritten text string or a hand-drawn sketch in the touch input from the user (e.g., user R). In some implementations, in response to receiving a handwritten text string (or a hand-drawn sketch), the handwriting recognition engine 112 may access a handwritten recognition model (e.g., 190A in FIG. 1B), to determine a raw text string (e.g., a text string predicted using the handwritten recognition model) corresponding to the handwritten text string. The prompt-generating engine 110 may be configured to generate a text prompt based on the raw text string that corresponds to the handwritten text string, where the text prompt can be processed using a generative model (e.g., 190B in FIG. 1B), to generate whiteboard content responsive to the handwritten text string (or the hand-drawn sketch) that is received via the whiteboard user interface. The whiteboard content may be rendered within the whiteboard user interface at a location that is offset from the handwritten text string (or the hand-drawn sketch).

In some implementations, the text prompt can include the raw text string that corresponds to (e.g., is predicted based on) the handwritten text string, and a default instruction to generate whiteboard content responsive to the raw text string. For instance, when the handwritten text string is determined to correspond to the term/word “cat”, the default instruction may be: generate an image and a short description of the word “cat”. In some other implementations, the text prompt can include, for instance, the raw text string that corresponds to the handwritten text string, and a modified instruction to generative whiteboard content (responsive to the raw text string). The modified instruction, for instance, modifies/replaces the default instruction based on any control input received based on user selection of one or more controls (e.g., a button requesting a pronunciation, a button requesting an image, etc.) displayed at the whiteboard user interface. For instance, if a user provides the handwritten text of “cat” and selects a control (e.g., a selectable graphical user interface element) for rendering a short description, the text prompt can include the raw text string that corresponds to the handwritten text string, and the modified instruction (e.g., an instruction to generate a short description for “cat”) instead of the default instruction to generate both an image for “cat” and a short description for “cat”. Optionally, the user selection of the control can be received prior to receiving the handwritten text string or subsequent to receiving the handwritten text string.

In some implementations, the handwriting recognition engine 112 can further access, through communications with the ASR engine, a speech recognition of audio data (if any) captured in a context associated with the handwritten text string, to verify accuracy of the recognition of the handwritten text string. The audio data, for instance, can be captured while the handwritten text string is being received. For instance, user R (e.g., a teacher in a classroom) may provide an utterance for “cat” while writing down the word “cat” within the whiteboard user interface using a finger or stylus. In this case, audio data capturing the utterance for “cat” may be processed to determine a corresponding speech recognition, and the corresponding speech recognition may be utilized to verify accuracy of the recognition of the handwritten text string of “cat” received via the whiteboard user interface. In some implementations, a pair that includes an image of the user's handwriting and speech recognized text may be used as training data, e.g., to train a handwritten recognition model (e.g., 190A in FIG. 1B) and/or a generative model (e.g., 190B/190C).

In some implementations, instead of having separate models to perform handwriting recognition of the handwritten text (or hand-drawn sketch, etc.) and whiteboard content generation in response to the handwritten text string (or hand-drawn sketch), a whiteboard content generation model (e.g., 190C in FIG. 1C) can be utilized to process an image depicting the handwritten text string (or hand-drawn sketch, etc.) as input, to generate a model output from which whiteboard content responsive to the handwritten text string (or hand-drawn sketch, etc.) is derived. The whiteboard content generated using the whiteboard content generation model can be rendered within the whiteboard user interface, with respect to the handwritten text string (or hand-drawn sketch, etc.).

As a non-limiting example, referring to FIG. 1B, user R can provide a handwritten input 11 (which can be a handwritten text string or a hand-drawn sketch) to a client device having a display 116. The display 116 can include a touch panel to receive handwritten input 11, and the handwritten input 11 can be provided by user R via a whiteboard user interface 17 of a whiteboard application installed at or accessible by the client device. The whiteboard user interface 17 can, but does not necessarily need to, include one or more controls (e.g., a first control 173A, a second control 173B, . . . , a Nth control 173N), where the one or more controls can each be a selectable graphical user interface (GUI) element for rendering a particular type (text, audio, image, video, etc.) of whiteboard content (sometimes referred to as “response content”) in response to the handwritten input 11. As a non-limiting example, the first control 173A may be configured to limit the whiteboard content (to be rendered within the whiteboard user interface 17) for the handwritten input 11 to be an image corresponding the handwritten input 11 (e.g., a handwritten word of “cat”), the second control 173B may be configured to limit the whiteboard content (to be rendered within the whiteboard user interface 17) for the handwritten input 11 to be a short description for an entity associated with the handwritten input 11 (e.g., a handwritten word or drawing of “cat”), . . . , and the Nth control 173N may be configured to limit the whiteboard content (to be rendered within the whiteboard user interface 17) for the handwritten input 11 to be a video clip (which may be animated or otherwise) for the entity associated with the handwritten input 11 (e.g., the handwritten word or drawing of “cat”). As will be described further herein, in some implementations, these controls 173A-N may be context controls in that they are selectively presented depending on what content the user has drawn on the whiteboard.

In some implementations, to generate the whiteboard content (that is responsive to the handwritten input 11 and that is to be rendered within the whiteboard user interface 17), an image containing the handwritten input 11 can be acquired (e.g., by taking a screenshot of the whiteboard user interface 17 (or a portion thereof) that shows the handwritten input 11. In some implementations, the acquired image can be pre-processed to remove background noise and/or to resize, and the pre-processed image can be processed by a handwriting recognition engine 112 using a handwriting recognition model 190A, to determine a raw text string 13 (which identifies or describes entities or topic(s), e.g., a typed word of “cat”) that corresponds to the handwritten input 11 (e.g., a handwritten word of “cat” or hand-drawn graphical representation of “cat”).

Optionally, the handwriting recognition model 190A can be a vision-language model trained or fine-tuned based on image-text pairs that each include an image containing a handwritten text string (or containing a hand-drawn sketch). Optionally, the handwriting recognition model 190A can be another trained machine learning model trained to perform object detection/classification. Given a screenshot of a hand-drawn sketch of “cat”, the trained vision-language model can be utilized to determine that the raw text string 13 that corresponds to “cat”. Alternatively or additionally, given a screenshot of a handwritten text of “cat”, the trained vision-language model can be utilized to determine that the raw text string 13 that corresponds to the hand-drawn sketch of “cat” is “cat”.

The raw text string 13 can be utilized to generate a text prompt 18. For instance, the prompt-generating engine 110 can generate the text prompt 18 to include the raw text string 13 and a default instruction to generate whiteboard content for the raw text string 13. The default instruction can be configured by the user (or a developer) of the whiteboard application as an instruction to generate one or more particular types of whiteboard content for the raw text string 13. For instance, the default instruction can be to generate an image for the raw text string 13. As another example, the default instruction can be to generate a short description for the raw text string 13. As a further example, the default instruction can be to generate an image for the raw text string 13 as well as a short description for the raw text string 13. As an additional example, the default instruction can be to generate an image for the raw text string 13, a pronunciation for the raw text string 13, and a short description for the raw text string 13. The default instruction, for instance, can be modified by user R through settings of a user account associated with the whiteboard application (mobile app, desk app, web-based app, etc.) that provide the whiteboard user interface.

Optionally, the prompt-generating engine 110 can generate the text prompt 18 based on the raw text string 13 and a modified instruction (instead of the default instruction). The modified instruction can be generated by modifying the default instruction 14 based on any control input 12 (and/or other factors, such as a speech recognition of a spoken utterance 19 of the user received in a context of the handwritten input 11). For instance, if user R has activated the first control 173A to limit the whiteboard content (to be rendered within the whiteboard user interface 17) for the handwritten input 11 to be an image corresponding the handwritten input 11, the modified instruction can be an instruction/request to generate an image corresponding to the raw text string 13.

The text prompt 18 can be received by a generative model engine 114 that accesses a generative model 190B (e.g., a large language model, “LLM”). The text prompt 18 can be processed as input, using the generative model 190B, to generate a model output from which a whiteboard content 15 (sometimes referred to as “responsive content”, “additional whiteboard content”, “to-be-generated whiteboard content”, etc.) is determined. The whiteboard content 15 can be rendered at a display 116 that displays the whiteboard user interface 17 showing the handwritten input 11 and/or the one or more controls (e.g., 173A˜173N). The whiteboard content 15 can be rendered in a location with respect to the handwritten input 11. For instance, the whiteboard content 15 can be rendered in a non-overlapping region with respect to the handwritten input 11.

In some implementations, the whiteboard content 15 can include content of different types, e.g., generated using a multi-headed decoder. For example, the whiteboard content 15 can include first content that is of a first type (e.g., an image) and second content that is a second type (e.g., an introduction in natural language). In some cases, the first content may be rendered using a first decoder head (e.g., decoded into an image) and the second content may be decoded using a second decoder head (e.g., decoded into natural language). In some implementations, the first content and the second content may be rendered simultaneously or in a certain order. For instance, the first content can be rendered in immediate response (e.g., within 0.3 second) to the handwritten input 11. The second content can be rendered automatically subsequent to the rendering of the first content (e.g., can be rendered since a certain period of time, e.g., 5 seconds, has passed since the rendering of the first content, or can be rendered since a video-type content finishes its play, etc.). Alternatively, the second content can be rendered based on receiving additional user input (e.g., a touch on a blank region within the whiteboard user interface 17) that initiates the rendering of the second content.

In the above example, in some implementations, the first content, the second content, and the handwritten input 11 can be rendered within the whiteboard user interface 17 in a non-overlapping manner. In some implementations, the first content, the second content, and/or the handwritten input 11 can be moved around by user R (e.g., via a two-finger dragging gesture received from user R at the whiteboard user interface 17). For instance, the first content, the second content, and/or the handwritten input 11 can each be enclosed by a bounding box, and a drag of the bounding box (for the first content, second content, or handwritten input 11) that is received at the whiteboard user interface 17 can causes the first content, second content, or handwritten input 11 to change its location and be moved around within the whiteboard user interface 17. This for instance, can save whiteboard space of the whiteboard user interface 17 when user R does not want to erase the first content, the second content, and/or the handwritten input 11 to save whiteboard space. In some implementations, the first content, second content, and/or handwritten input 11 can be removed/erased by user R from the whiteboard user interface 17. For instance, a quick double click (or touch) or other gesture can be used by user R to erase the first content, second content, and/or handwritten input 11 from the whiteboard user interface 17.

In various implementations, instead of using separate models (the vision-language model 190A and the generative model 190B), a single model (i.e., a whiteboard content generation model 190C) can be applied to generate the whiteboard content based on the handwritten input 11. The whiteboard content generation model 190C, for instance, can be a multimodal generative model, a visual question answering (VQA) model, etc.

Referring to FIG. 1C, user R can provide the handwritten input 11 to a client device. The handwritten input 11 can be received via the whiteboard user interface 17 of a whiteboard application installed at or accessible by the client device. The handwritten input 11 can be visually rendered at the whiteboard user interface 17 (as whiteboard content) and an image (e.g., screenshot) capturing/containing the handwritten input 11 can be acquired. The image containing the handwritten input 11 can be pre-processed, for instance, to remove a noise (e.g., background noise) from the image and/or to resize the image, etc. The pre-processed image can be provided to a whiteboard content generation engine 115 that is in communication with the whiteboard content generation model 190C. The pre-processed image can be processed as input, using the whiteboard content generation model 190C, to generate the whiteboard content 15 (sometimes referred to as “additional whiteboard content”) that is in response to the handwritten input 11. The whiteboard content 15 can be rendered at the whiteboard user interface 17 of a display 116 of the client device. For example, the whiteboard content 15 can be rendered with respect to the handwritten input 11 at the whiteboard user interface 17, e.g., in a location offset from the handwritten input 11.

The whiteboard content generation model 190C can be trained using one or more training datasets. The one or more training datasets can include, for instance, a first training dataset having multiple training instances, where each of the multiple training instances can include a distinct image capturing a handwritten text string as a training instance input and a ground truth response that is in response to the handwritten text string. The handwritten text string can be in English and/or in other language(s). For instance, the multiple training instances in the first training dataset can include a first training instance, where the first training instance can include a handwritten text string of “horse” as a training instance input. The first training instance can further include a natural language response (e.g., “horses are strong, intelligent, and social animals that live together. A horse has four legs, two eyes, and two ears.”), an image of a horse, a video showing how to pronounce the word “horse”, and/or other types of content, as a ground truth response that corresponds to the handwritten text string of “horse”.

Alternatively or additionally, the one or more training datasets can include, for instance, a second training dataset having multiple training instances, where each training instance can include a distinct handwritten sketch. Optionally, the second training dataset can include a plurality of subsets. For instance, the hand-drawn sketch can be a handwritten math equation or expression, and the plurality of subsets can include a first subset having multiple training instances each including a distinct handwritten math equation (or expression) as a training instance input. Each of the multiple training instances in the first subset, for instance, can include a solution to the math equation (or a simplification of the math expression, etc.) as a ground truth response that corresponds to the handwritten math equation (or expression) in a corresponding training instance input in the first subset.

Alternatively or additionally, the hand-drawn sketch can be a hand-drawn diagram of a circuit, and the plurality of subsets can include a second subset having multiple training instances each including a distinct hand-drawn circuit as a training instance input. Each of the multiple training instances in the second subset, for instance, can include a current flow (and/or other types of information, such as names of each component in the circuit) as a ground truth response that corresponds to a corresponding training instance input in the second subset.

Alternatively or additionally, the hand-drawn sketch can be a handwritten chemical formula (e.g., molecule), and the plurality of subsets can include a third subset having multiple training instances each including a distinct handwritten chemical formula as a training instance input. Each of the multiple training instances in the third subset, for instance, can include a name of a chemical having the chemical formula (and/or other content, such as a brief introduction of the chemical, etc.) as a ground truth response that corresponds to a corresponding training instance input in the third subset.

Alternatively or additionally, the hand-drawn sketch can be a hand-drawn object, and the plurality of subsets can include a fourth subset having multiple training instances each including a distinct hand-drawn object as a training instance input. Each of the multiple training instances in the fourth subset, for instance, can include a name of the object (and/or other content, such as labels of different components of the object, an introduction of the object, etc.) as a ground truth response that corresponds to a corresponding training instance input in the fourth subset. It is noted that numbers and descriptions of the first and second training datasets, as well as numbers and descriptions of the subsets, are not limited herein. For instance, the plurality of subsets can include a fourth subset having multiple training instances each including a distinct hand-drawn sequence of dots as a training instance input, and including a line connecting the distinct hand-drawn sequence of dots as a ground truth response that corresponds to the training instance input.

In some implementations, after being trained, the whiteboard content generation model 190C can be utilized to generate, for a handwritten text string describing an entity (e.g., “cat”), whiteboard content (associated with the entity) that is to be rendered within the whiteboard user interface 17. Depending on how the whiteboard content generation model 190C is prompted and/or trained, the generated whiteboard content associated with the entity of “cat” can include, for instance, a list of words that rhyme with the entity “cat”, such as “bat,” “hat” and “mat.” Alternatively or additionally, the whiteboard content associated with the entity of “cat” can include syllable(s) for the word “cat”. Alternatively or additionally, the whiteboard content associated with the entity of “cat” can include a short video on pronunciation for the word “cat”, where the short video may include a close-up of a human mouth pronouncing the word “cat” in a relatively slow speed. In some other implementations, the whiteboard content generation model 190C can be additionally or alternatively trained to, for a handwritten text in a foreign language not familiar to a user, translate the handwritten text in the foreign language to a native language of the user.

In some other implementations, the trained whiteboard content generation model 190C can be utilized to calculate a solution to a handwritten math problem, suggest one or more alternative solutions (if any), and/or generate a link to relevant sources. In some other implementations, the trained whiteboard content generation model 190C can be utilized to, for a handwritten solution to a math problem, determine feedback on the handwritten solution, determine one or more additional steps or information, and/or determine one or more alternative solutions (if any).

In some other implementations, the trained whiteboard content generation model 190C can be utilized to identify each circuit component in a hand-drawn diagram of a circuit and/or determine a current flow of the circuit. In some other implementations, the trained whiteboard content generation model 190C can be utilized to determine a name of a handwritten chemical formula and/or one or more properties of the chemical formula. In some other implementations, the trained whiteboard content generation model 190C can be additionally or alternatively utilized to determine a label for each part of a hand-drawn sketch of a molecule and determine a molecular formula for the molecule. In some other implementations, the trained whiteboard content generation model 190C can be additionally or alternatively utilized to, for a handwritten shape (e.g., circle, square, triangle), identify the handwritten shape and provide feedback on the handwritten shape. In some other implementations, the trained whiteboard content generation model 190C can be additionally or alternatively utilized to, for a plurality of hand-drawn dots drawn by a child, connect the plurality of handwritten dots to form a line and/or provide feedback.

Optionally, the whiteboard user interface 17 can include one or more controls (e.g., 173A˜173N), and user selection of one or more of the controls can be applied to select, tailor, or limit the type(s) of content to be included in the whiteboard content to be rendered as a response to the handwritten input 11 within the whiteboard user interface 17. For instance, a user selection of the control 173A may cause an image (e.g., an image of a cat) describing an entity (e.g., a cat) in the handwritten input 11 to be rendered within the whiteboard user interface 17 as the whiteboard content responsive to the handwritten input 11. Repeated descriptions may be found elsewhere and are omitted for sake of clarity.

Optionally, the whiteboard content 15 can be generated in a similar manner or style as the handwritten input 11. Optionally, as described above, when the whiteboard content 15 includes different types of content, the different types of content can be rendered simultaneously or at different times. Optionally, the different types of content can also be rendered at different locations of the whiteboard user interface 17. Optionally, the different types of content and/or the handwritten input 11, as described above, can be moved around within the whiteboard user interface 17.

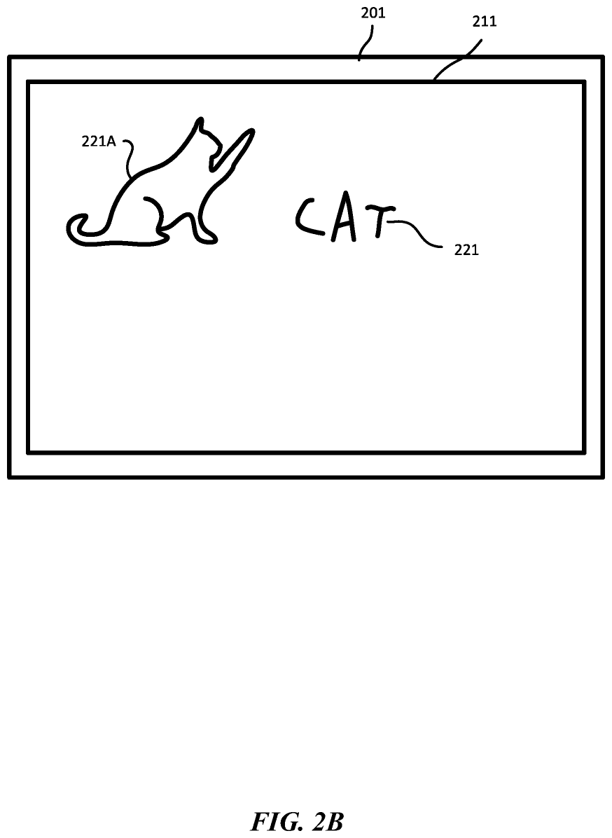

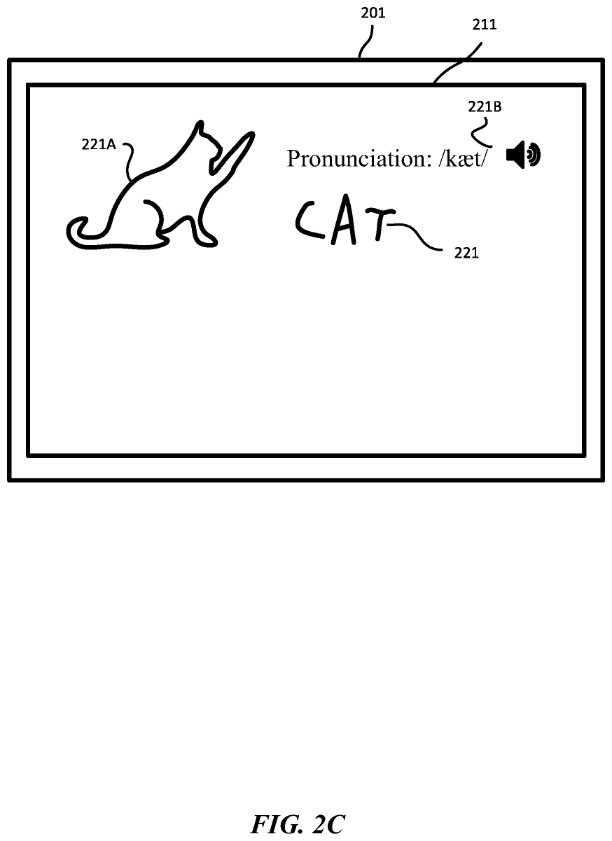

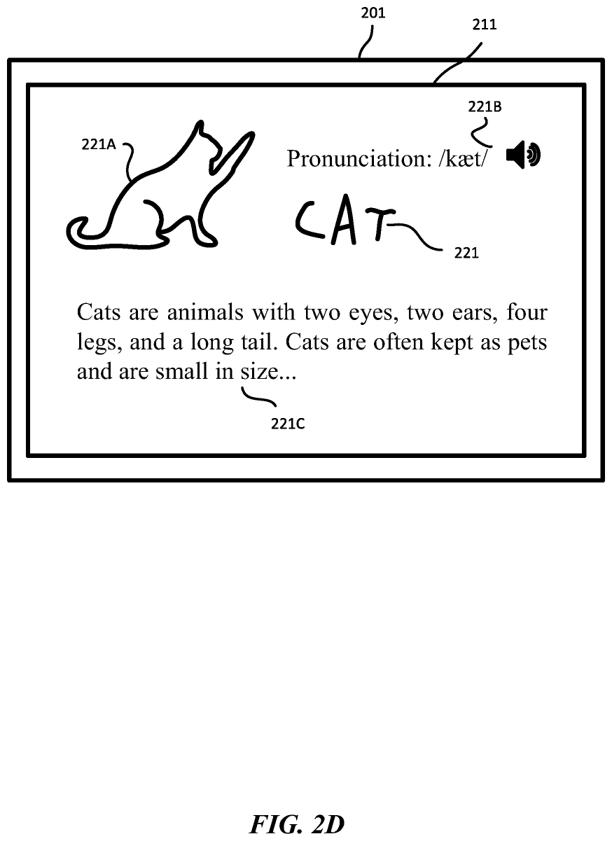

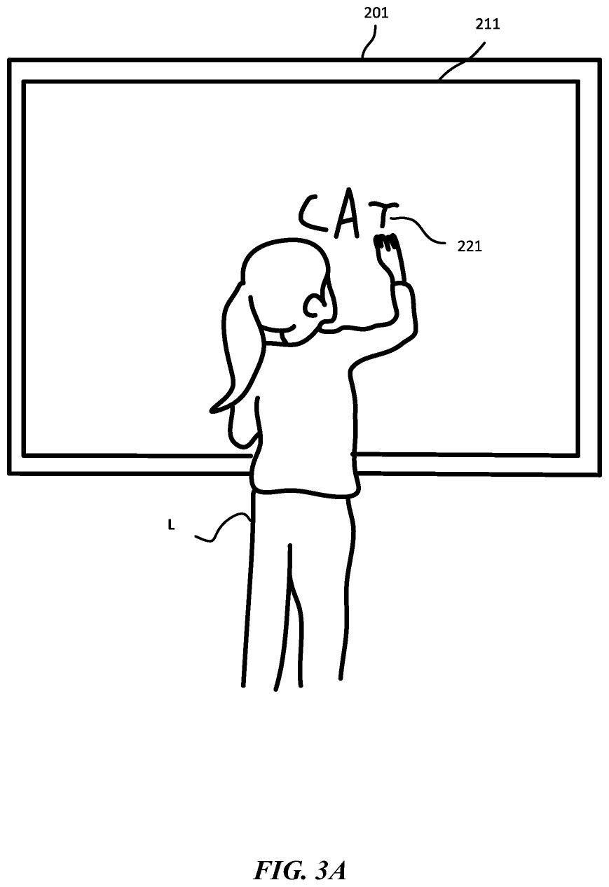

Turning now to FIGS. 2A, 2B, and/or 2C, one or more scenarios where whiteboard content is rendered responsive to a handwritten input is illustrated. As shown in FIG. 2A, user L can be using an electronic whiteboard to write a term/word (e.g., handwritten word of “CAT”). The electronic whiteboard can include a touch screen 201, and the word “CAT” written by user L can be received via a whiteboard user interface 211 of the touch screen 201 as a handwritten input 221. An image containing the handwritten input 221 can be pre-processed (e.g., to remove background noise and/or to resize the image into a predetermined size), and the pre-processed image containing the handwritten input 221 can be processed using a deep learning model (e.g., the aforementioned whiteboard content generation model) to generate a model output from which whiteboard content responsive to the handwritten input 221 is derived. As shown in FIG. 2B, in some implementations, the whiteboard content, for instance, can include an image 221A depicting a cat, as a response to the handwritten word “CAT” 221.

In some other implementations, as shown in FIG. 2C, the whiteboard content can include a pronunciation 221B for the handwritten word “CAT” in addition to the image 221A. In some other implementations, as shown in FIG. 2D, the whiteboard content can include a short description 221C for the word “CAT”, in addition to the pronunciation 221B for the handwritten word “CAT” and the image 221A. In some other implementations, while not depicted in FIGS. 2A˜2D, the whiteboard content can include a pronunciation 221B for the handwritten word

“CAT”, without including the image 221A. In some other implementations, while not depicted in FIGS. 2A˜2D, the whiteboard content can include the short description 221C for the word “CAT”, without including the pronunciation 221B for the handwritten word “CAT” or the image 221A. Descriptions of the whiteboard content, however, are not limited herein, and can include any applicable type of content. For instance, the whiteboard content can alternatively or additionally include a list of words that rhyme with the “cat”, where the list of words can include, for instance, “bat,” “hat” and “mat.” The list of words, for instance, can be rendered using a typed font or can be rendered in a style (e.g., size, writing features, etc.) the same as or similar to the handwritten word of “cat”.

It is noted that the image 221A, the pronunciation 221B, and/or the short description 221C, if included in the whiteboard content to be rendered within the whiteboard user interface 17, can be rendered at different locations of the whiteboard user interface 17 and/or can be rendered at different times. For instance, as shown in FIG. 2B˜2D, the image 221A, the pronunciation 221B, and/or the short description 221C can be rendered in a certain order, automatically or manually. In some implementations, a vision sensor such as a camera that is mounted on the client device or elsewhere in the environment (e.g., when a projector is used to project whiteboard content) may be used to determine a position of the user, e.g., relative to an audience. In some such implementations, the user's determined location may be used to select a location on the whiteboard where the whiteboard content will be rendered, e.g., so that the audience's view of the whiteboard content is not obstructed by the user.

Put another way, in some implementations, the whiteboard content can include different types of content responsive to the handwritten input 221. As described above, the different types of content can be rendered within the whiteboard user interface 201 at different points of time. For instance, the pronunciation 221B for the handwritten word “CAT” can be rendered subsequent to the rendering of the image 221A, and the short description 221C can be rendered subsequent to the rendering of the pronunciation 221B. The pronunciation 221B can be rendered immediately in response to a completed rendering of the image 221A, and the short description 221C can be rendered immediately in response to a completed rendering of the pronunciation 221B. Alternatively, the pronunciation 221B can also be rendered within a predefined period of time since a completed rendering of the image 221A, and the short description 221C can be rendered within the predefined period of time since a completed rendering of the pronunciation 221B. Alternatively, the pronunciation 221B can also be rendered subsequent to the image 221A based on a touch input from the user (e.g., a quick, double click at a blank region of the whiteboard user interface 17), and/or the short description 221C can be rendered subsequent to the pronunciation 221B subsequent to the image 221A based on the touch input from the user. Descriptions of the whiteboard content (and portions thereof) and its rendering manner are not limited herein.

In some implementations, the whiteboard user interface 211 can include one or more controls (e.g., selectable graphical user interface (GUI) elements). In some implementations, the one or more controls can be rendered and remain rendered at the whiteboard user interface 211. In these implementations, the one or more controls can be predefined, and one or more of the controls may be contextual in that they may be selectively activated (selectable) or deactivated (un-selectable) depending on whiteboard content (e.g., handwritten input 221 from human user(s) and/or synthesized content generated using one or more machine learning models, e.g., whiteboard content generation model 190C in FIG. 1C) that is rendered at the whiteboard user interface 211. In some implementations, the generative model itself may be prompted to generate contextual controls based on various user input. For instance, if the user draws a sketch of an object and/or provides spoken input indicating that they've drawn a sketch of an object, the generative model may be prompted to generate controls that allow the user to see information about the object in other modalities, such as text, pronouncement, etc.

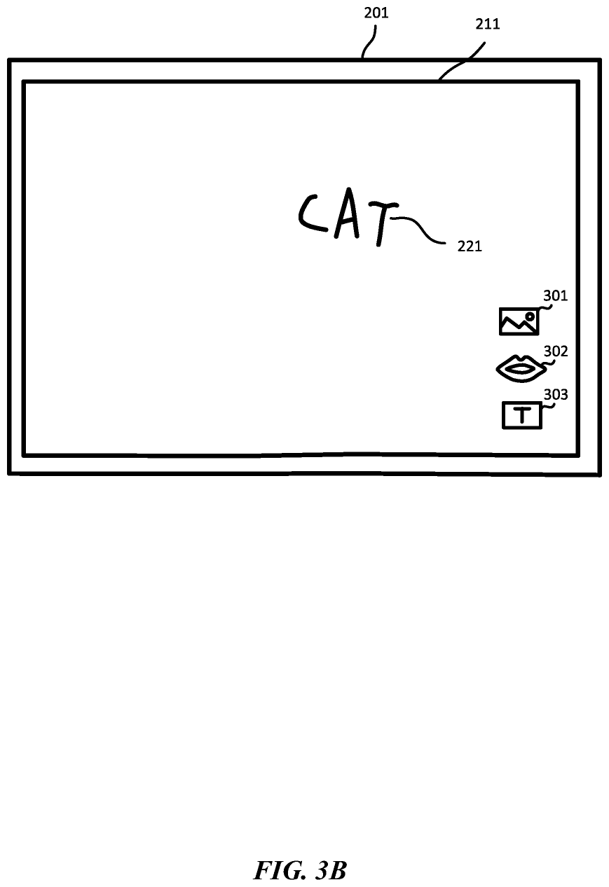

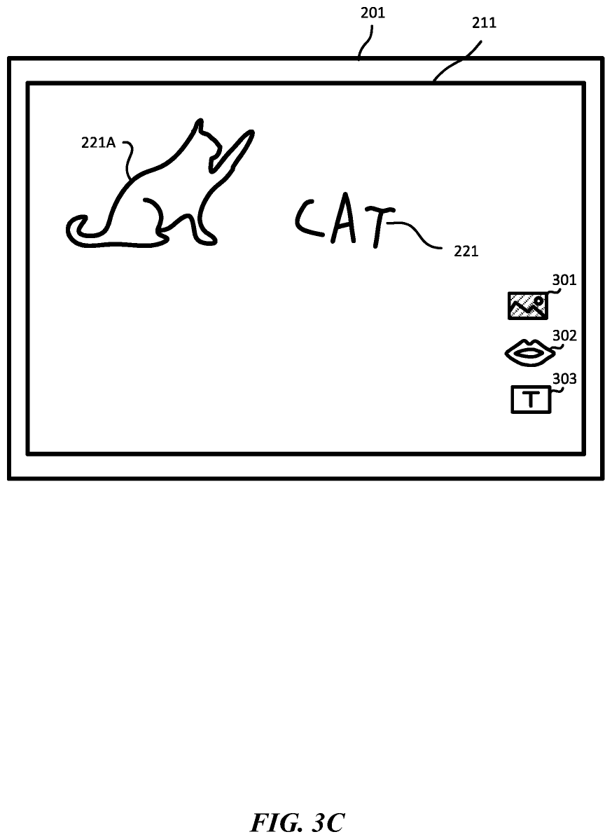

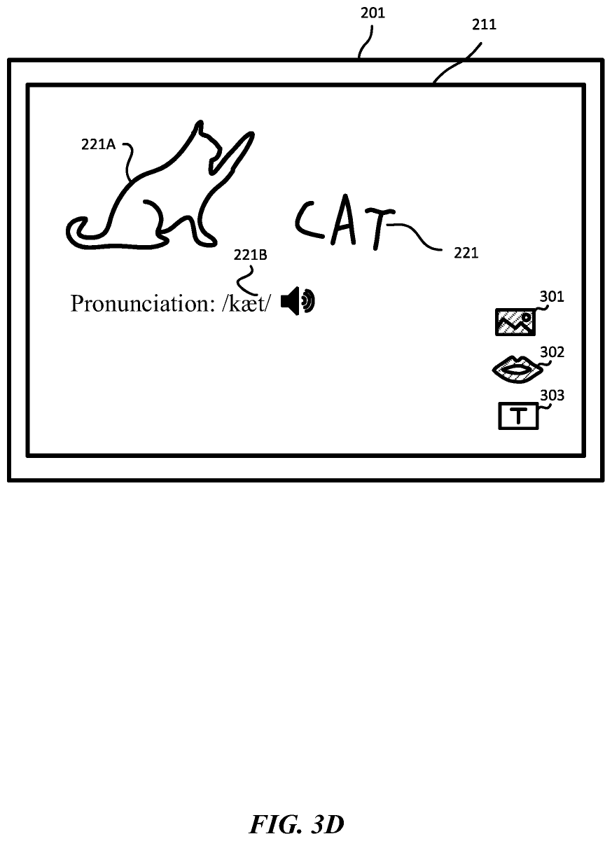

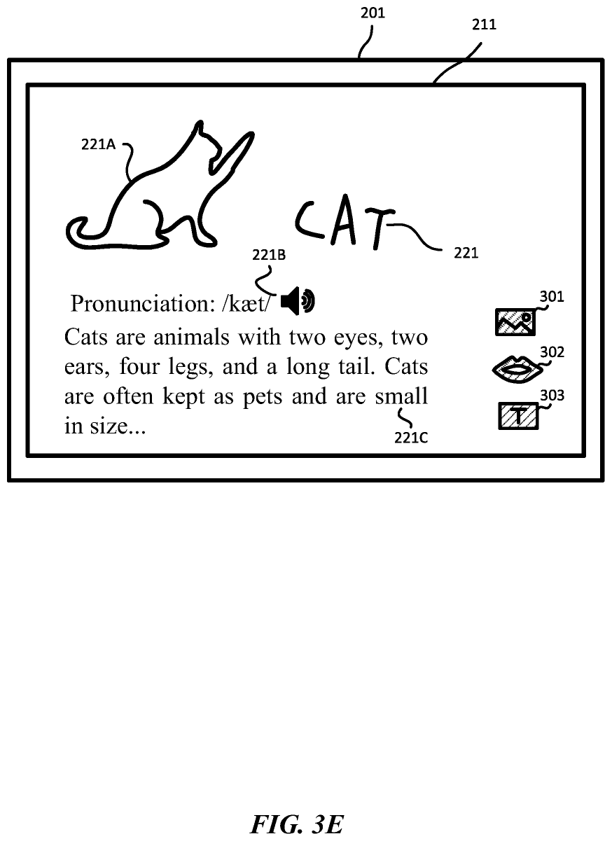

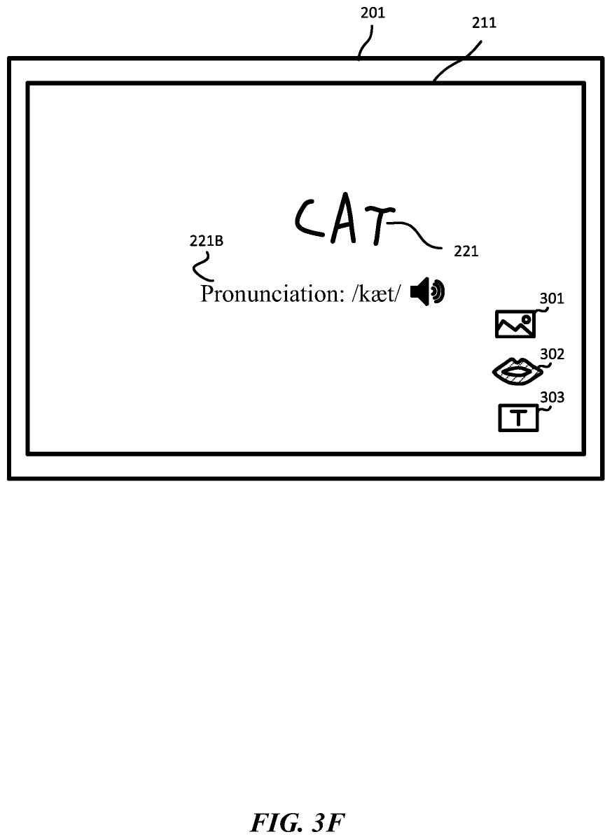

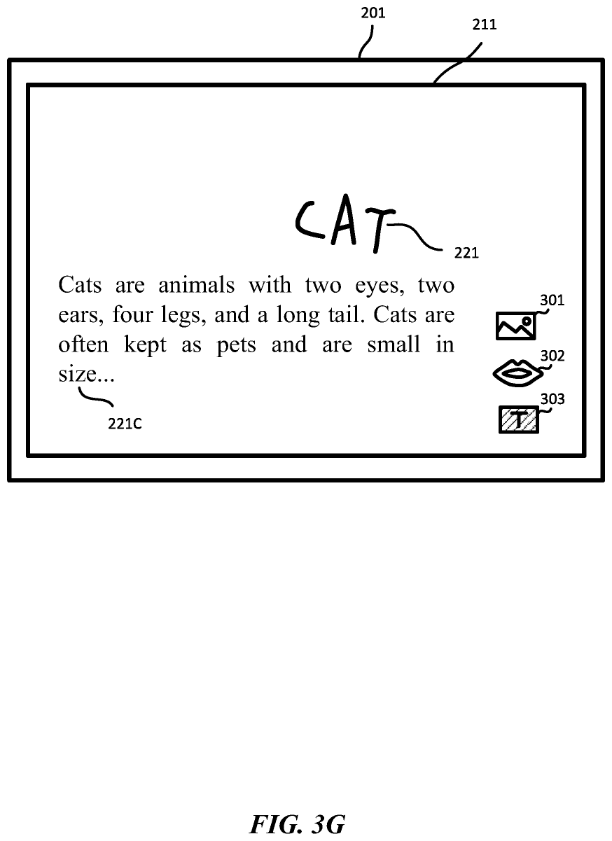

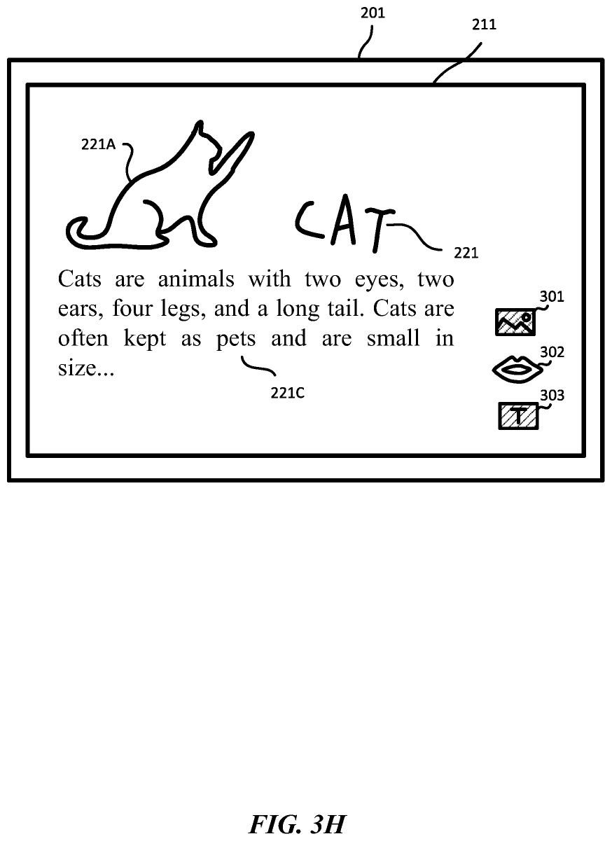

In some other implementations, one or more controls can be rendered in response to the handwritten input 221. In these implementations, for instance, types or functions of the one or more controls (that are rendered in response to the handwritten input 221) can depend on topic(s) and/or entities detected in the handwritten input 221. As a non-limiting example, referring to FIG. 3A, the handwritten input 221 can be received from user L via the whiteboard user interface 211, and in response to determining that the handwritten input 221 includes or corresponds to a topic and/or an entity (e.g., an object of “cat”) using a trained machine learning model (e.g., 190A, which can be a lightweight convolutional neural network “CNN” trained for object classification/detection), a plurality of controls can be rendered (FIG. 3B), where the plurality of controls can include a first selectable element 301, a second selectable element 302, a third selectable element 303. The number and format of the selectable elements shown in the figures (e.g., FIG. 3B) are provided for purpose of illustration, and is not intended to be limiting.

In some implementations, user L can select one of the plurality of controls prior to providing the handwritten input 221 (in case the plurality of control is configured to be rendered prior to receiving any user input and remain rendered at the whiteboard user interface 211).

In some implementations, alternatively, as shown in FIG. 3C, user L can select one of the plurality of controls subsequent to providing the handwritten input 221. In this case, the plurality of controls can be tailored to the handwritten input 221 (e.g., different set of controls can be rendered for different categories of handwritten input 221). For instance, a first set of controls can be rendered in response to determining that the handwritten input 221 corresponds to a handwritten text string, a second set of controls (with one or more controls different from those in the first set of controls) can be rendered in response to determining that the handwritten input 221 corresponds to a hand-drawn object. Optionally, for different entities, objects, or topics determined from the handwritten input 221, different controls can be rendered. For example, a set of controls can be rendered in response to determining that the handwritten input 221 corresponds to a mathematical question and an additional set of controls (different from the set of controls) can be rendered in response to determining that the handwritten input 221 corresponds to a chemical formula. It is noted that descriptions of the control(s) and the way to render different control(s) are not limited herein.

As shown in FIG. 3C, user L can select or activate the first selectable element 301 which limits the whiteboard content to be (or to include) an image responsive to the handwritten input 221-“CAT”. In this case, the image 221A of “CAT” can be generated using the whiteboard content generation model based on processing an image containing the handwritten input 221 and a control input that corresponds to user selection of the first selectable element 301 (e.g., that limits the whiteboard content to include an image). For example, the aforementioned prompt-generating engine 110 can be used to generate/formulate an input prompt (e.g., text prompt 18) that includes data indicative of the image containing the handwritten input 221 and an instruction (sometimes referred to as a “request”) to generate an image (or graphical representation) for one or more topics or entities detected in the handwritten input 221 as whiteboard content (sometimes referred to as “additional whiteboard content”).

In the above example, the instruction to generate the graphical representation for one or more topics or entities detected in the handwritten input 221 can be a modified instruction that modifies the default instruction (e.g., the aforementioned default instruction 14) to generate whiteboard content in view of the control input (that corresponds to user selection of the first selectable element 301 which limits the whiteboard content to include an image responsive to the handwritten word of “CAT”). In this example, the input prompt can be processed as input, using the whiteboard content generation model 190C (e.g., the VQA model) or the generative model 190B (e.g., LLM), to generate a model output (which may but does not necessarily need to include an image tag) from which a graphical representation (e.g., a human captured image or synthesized image, e.g., image 221A) for an entity (e.g., “cat”) in the handwritten input 221 is generated or retrieved. The image may be drawn based on the generative model, assuming it is capable, and/or the image may be retrieved using an image search.

Referring now to FIG. 3D, user L can select or activate both the first selectable element 301 and the second selectable element 302, where the second selectable element 302 is configured to limit the whiteboard content to include content relating to a pronunciation of the word “CAT”. In this case, both the image 221A of “CAT” and the content 221B relating to the pronunciation of the word “CAT” can be determined using the whiteboard content generation model 190C (or the generative model 190B, or other applicable machine learning model) and be rendered at the whiteboard user interface 211.

To generate additional whiteboard content (e.g., the image 221A and the content 221B) that is in addition to the whiteboard content (i.e., the handwritten input 221), an input prompt that includes data indicative of the image containing the handwritten input 221 and an instruction to generate an image (or graphical representation) for one or more topics or entities detected in the handwritten input 221 as well as content (or video) introducing pronunciation for entities detected in the handwritten input 221 can be generated.

In the above example, the instruction to generate both the graphical representation and the content introducing pronunciation can be processed as input, using the whiteboard content generation model 190C (e.g., the VQA model) or the generative model 190B (e.g., LLM), to generate a model output (which may but does not necessarily need to include an image tag and a video tag) from which the image 221A and the content 221B are generated or retrieved.

As a third example, referring to FIG. 3E, user L can select or activate the first selectable element 301, the second selectable element 302, and the third selectable element 303, where the third selectable element 302 is configured to limit the whiteboard content to a short description for an entity determined from the handwritten input 221. In this case, the image 221A of “CAT”, the content 221B relating to the pronunciation of the word “CAT”, and a short description 221C for the word “CAT”, can be rendered at the whiteboard user interface 211. Descriptions of generating the image 221A, 221B, and 221C can be similar to descriptions above, and are omitted herein for the sake of brevity.

As a fourth example, referring to FIG. 3F, user L can select or activate the second selectable element 302. In this case, the content 221B relating to the pronunciation of the word “CAT” can be rendered, without rendering of the image 221A of “CAT” and the short description 221C for the word “CAT”.

As a fifth example, referring to FIG. 3G, user L can select or activate the third selectable element 303. In this case, the short description 221C for the word “CAT” can be rendered within the whiteboard user interface 211. As a sixth example, referring to FIG. 3H, user L can select or activate the first selectable element 301 and the third selectable element 303. In this case, the image 221A of “CAT” and the short description 221C for the word “CAT” can be rendered within the whiteboard user interface 211. The whiteboard content generated in this way (e.g., based on user selection of one or more controls) can include types of content specified in one or more selected controls.

In some implementations, instead of user selection of one or more controls (e.g., the selectable element(s) 301, . . . , and/or 305), user L can provide a spoken utterance 19 requesting a certain type (or one or more types) of content to be generated as the whiteboard content responsive to the handwritten input 221. For instance, the spoken utterance 19 can be, “Let's see a picture of it”, “Let's see a picture of the cat”, or “Let's see a picture and an introduction of the cat’, etc. In these implementations, the transcription of the spoken utterance and an image containing the handwritten input 11 can be processed using the whiteboard content generation model 190C, to generate a model output from which the whiteboard content 15 is generated. The whiteboard content 15 generated in this way can include types of content specified in the spoken utterance 19.

Optionally, the spoken utterance 19 can be a triggering event that triggers the generation of the whiteboard content 15. There can also be other triggering event(s) that trigger the generation of the whiteboard content 15. For instance, the generation of the whiteboard content 15 (e.g., using the whiteboard content generation model 190C) can be triggered if no additional handwritten input is received from a user after a predetermined duration has passed since the handwritten input 221 is received. By monitoring triggering event(s) to trigger the generation of the whiteboard content 15, computing resources (e.g., memory resources, battery resources, network resources, etc.) utilized in transmitting data, generating input/textual prompt, and running the trained machine learning models (e.g., 190A, 190B, and/or 190C) can be reduced.

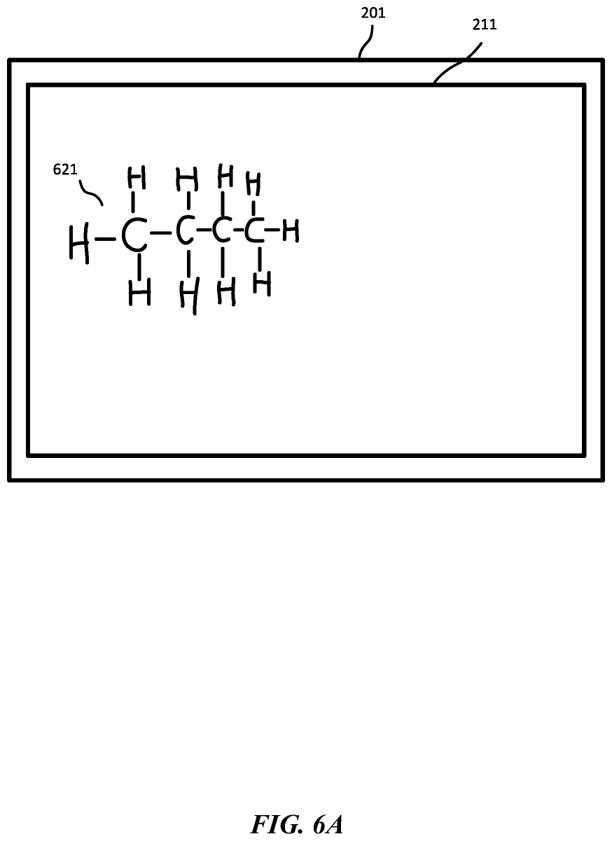

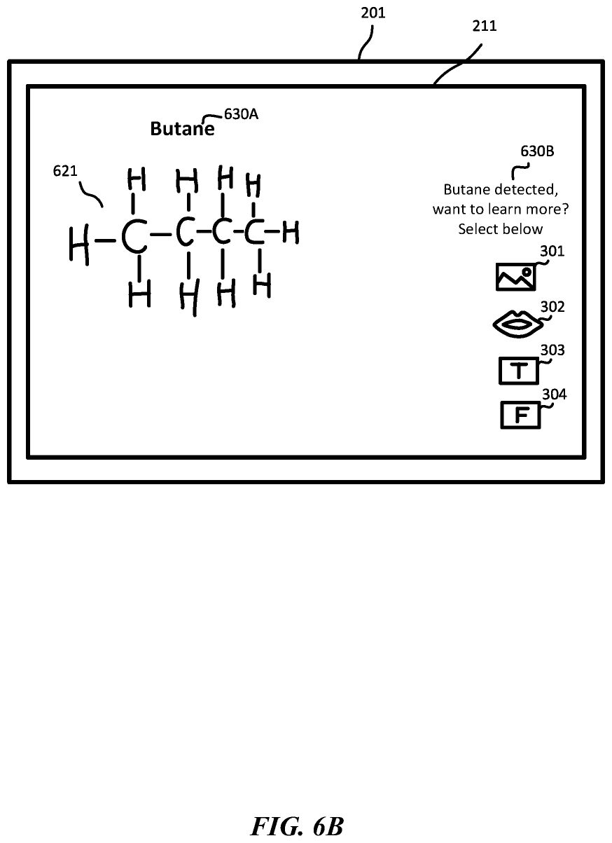

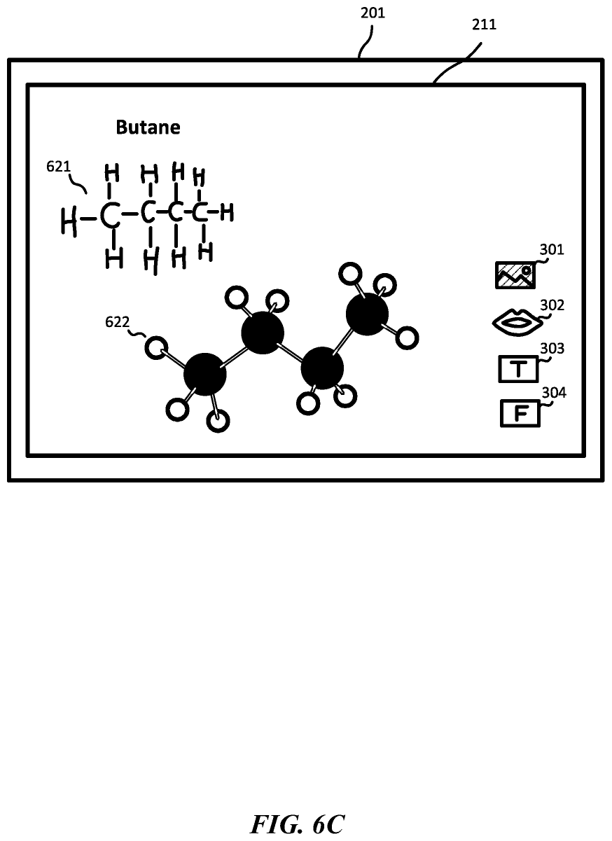

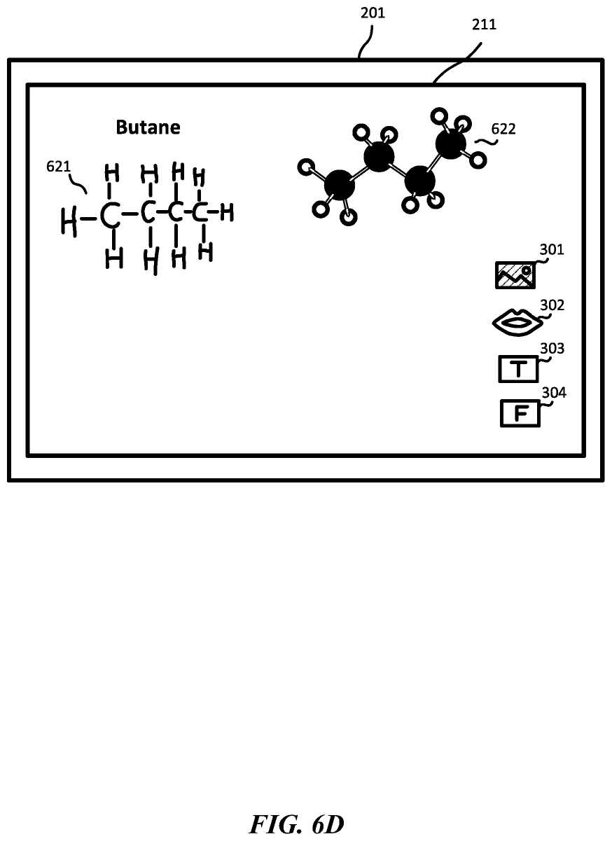

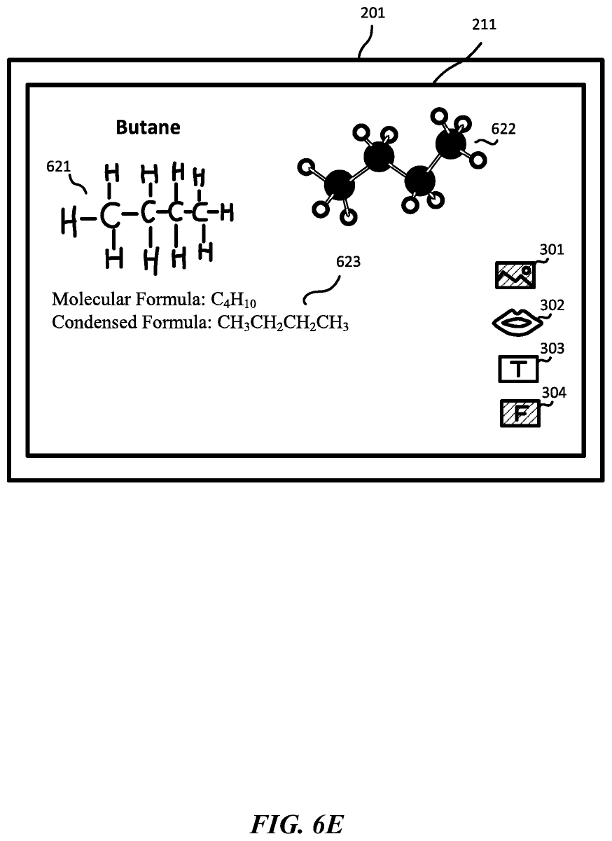

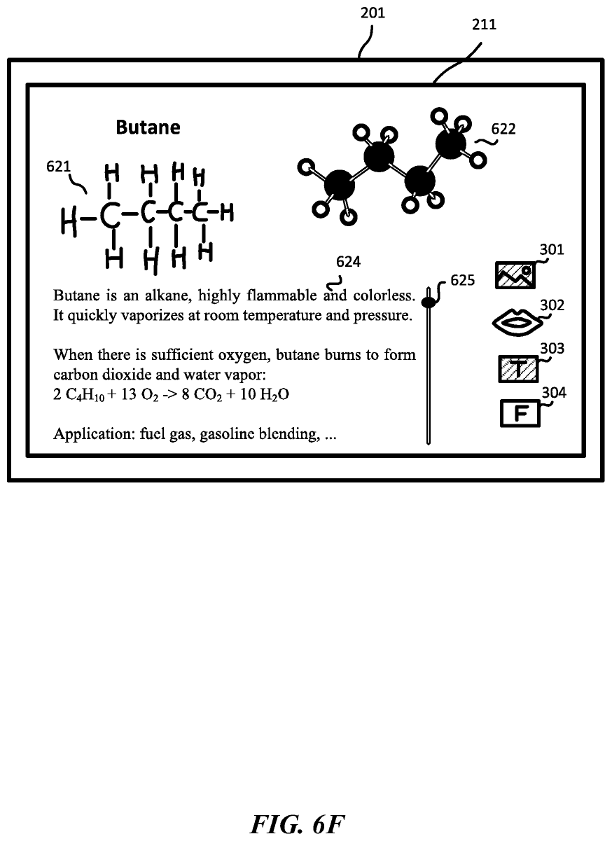

Referring now to FIGS. 6A, 6B, 6C, 6D, 6E, and 6F, an additional scenario is provided as a non-limiting example. A user may provide a handwritten input 621 that corresponds to structural formula for chemical “butane”, to a touch screen 201 of a client device. As shown in

FIG. 6A, the handwritten input 621 can be received via the whiteboard user interface 211 that is rendered at the touch screen 201, and can be rendered in real time as whiteboard content within the whiteboard user interface 211.

In some implementations, optionally, as shown in FIG. 6B, in response to receiving the handwritten input 621 that depicts the structural formula for chemical “butane”, a trained machine learning model (e.g., CNN or visual language model) trained for object classification/detection can be applied to determine that the handwritten input 621 includes an entity/object of “butane”. In this case, a caption or label 630A (“Butane”) or other identification of the entity detected in the handwritten input 621 can be rendered visually at the whiteboard user interface 211. Alternatively or additionally, a plurality of controls (e.g., 301˜303 as described above, and a control 304 for rendering content showing other types of formulas for chemicals) can be rendered in response to determining that the handwritten input 621 includes an entity/object (e.g., “butane”) that belongs to a particular category (e.g., “chemicals”). Put another way, the functions or types of the controls rendered in response to the handwritten input 621 can depend on category of object(s) or entities or topics parsed/detected from the handwritten input 621. Optionally, the plurality of controls (e.g., 301˜304) can be rendered along with a prompt 630B, such as “Butane detected, want to learn more? Select below”, that reminds a user to select one or more of the plurality of controls (e.g., 301˜304).

In response to the user selecting the first control 301 (see FIG. 6C) which limits the to-be-generated whiteboard content (“additional whiteboard content”) to be (or to include) an image showing an entity (e.g., “butane”) detected from the handwritten input 621, first whiteboard content (generated based on processing at least data indicative of an image containing the handwritten input 621 and a control input indicating user selection of the first control 301) can include an image 622 showing the entity detected from the handwritten input 621. While the image 622 is depicted as an image showing a molecular model (ball-and-stick) of the chemical “butane”, it is noted that the image 622 can be other applicable image such as a bottle containing butane, a product having butane as an ingredient, etc., and is not limited to descriptions in the figures and the specification.

The image 622 can be generated using a generative machine learning model (e.g., 190C or 190B). For instance, to generate the image 622, an input prompt can be generated to include data indicative of an image containing the handwritten input 621 (or, alternatively, a text description of the detected entity of “butane”) and an instruction (in natural language) to generate an image for an entity detected from the handwritten input 621. The input prompt can be processed as input, using the whiteboard content generation model 190C (or the generative model 190B), to generate first model output from which first whiteboard content (e.g., the image 622) is determined or generated.

In some implementations, the image 622 may be rendered at the whiteboard user interface 211 in a location offset from the handwritten input 621. In some implementations, this location may be selected to avoid obstructing the audience's view based on a position of the user that is determined, for instance, based on image(s) captured by one or more cameras. Optionally, the image 622 may be rendered at the whiteboard user interface 211 with a predetermined size. In this case, the user may be able to modify the location and/or the size of the image 622 (or other types of whiteboard content generated using, e.g., the whiteboard content generation model 190C). For instance, referring to FIGS. 6C and 6D, the user may move the image 622 from a bottom area of the whiteboard user interface 211 to an upper-right corner of the whiteboard user interface 211. The user may also reduce the size of the image 622 in order to view or in preparation for reviewing more synthesized whiteboard content (e.g., generated using the whiteboard content generation model 190C.).

In some implementations, referring to FIG. 6E, the user may additionally select the fourth control 304 to view additional types (e.g., molecular formula and condensed formula) of formula for the chemical “butane” detected from the handwritten input 621. In this case, an input prompt can be generated to include data indicative of an image containing the handwritten input 621 (or a text description of the detected entity of “butane”) and an instruction to generate whiteboard content that shows molecular formula and condensed formula for the detected entity in the handwritten input 621. The input prompt can be processed as input, using the whiteboard content generation model 190C (or the generative model 190B), to generate second model output from which second whiteboard content showing a molecular formula for the chemical “butane” as well as showing a condensed formula for the chemical “butane” are derived. The content 623 showing both the molecular formula and the condensed formula for the chemical “butane” can be rendered at the whiteboard user interface 211, along with the handwritten input 621 and/or the image 622.

In some implementations, referring to FIG. 6F, the user de-selects the fourth control 304 and additionally selects the third control 303 to view an introduction or description of the chemical “butane” detected from the handwritten input 621. In this case, an input prompt can be generated to include data indicative of an image containing the handwritten input 621 (or a text description of the detected entity of “butane”) and an instruction to generate whiteboard content that shows a description of the detected entity in the handwritten input 621. The input prompt can be processed as input, using the whiteboard content generation model 190C (or the generative model 190B), to generate third model output from which third whiteboard content showing the description 624 for the chemical “butane” is derived. The description 624 can be rendered at the at the whiteboard user interface 211 in response to the user selecting the third control 303, along with the handwritten input 621 and/or the image 622. Optionally, when a length of the description 624 exceeds a predefined length (e.g., 50 words), a slider 625 can be rendered for a user to review the description 624 in its entirety. It is noted that the content 623 can be removed from the whiteboard user interface 211 in response to the user de-selecting the fourth control 304. It is further noted that once generated, the content 623 (and/or other generated whiteboard content such as 621, 622, 624) can be stored/cached locally at a client device in communication with the touch screen 201 for a certain period of time, so that if the user decides to re-select the control 303 (or other controls), whiteboard content generation process does not need to be repeated and the content 623 can be re-rendered in response to the user re-selecting the control 303.

It is noted that, as described above, in some implementations, a CNN is utilized to detect the entity “butane” from the handwritten input 621. In these implementations, to save cost and computing resources as well as to reduce a latency in rendering the whiteboard content that is generated based at least on the handwritten input 621, the input prompt can be generated to include a text string identifying the entity “butane” (instead of the data indicative of an image containing the handwritten input 621), along with an instruction to generate whiteboard content in view of any control input (audible user input, user profile, etc.). In this case, the input prompt can be processed using the generative model 190B (e.g., LLM) instead of the whiteboard content generation model 190C (e.g., VQA model).

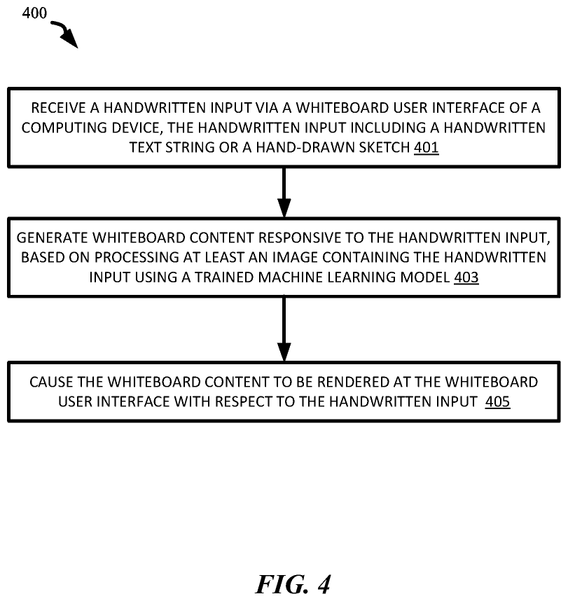

Turning now to FIG. 4, a flowchart is depicted that illustrates an example method of generating content responsive to a handwritten input, in accordance with various aspects of the present disclosure. This system of the method 400 includes one or more processors, memory, and/or other component(s) of computing device(s) (e.g., client computing device 10 of FIG. 1, one or more servers, and/or other computing devices). Moreover, while operations of the method 400 are shown in a particular order, this is not meant to be limiting. One or more operations may be reordered, omitted, and/or added.

At block 401, the system receives a handwritten input via a whiteboard user interface at a computing device, the handwritten input including a handwritten text string and/or a hand-drawn sketch. As a non-limiting practical example, the handwritten input can be a math question of “What is the area of a triangle with a base of 10 cm and a height of 5 cm?” As other examples, the handwritten input can also be a hand-drawn picture showing an animal (e.g., cat) or other object (e.g., a house), a handwritten word of an object (e.g., “cat”) or event (e.g., Superbowl), a math equation, a math expression, a diagram (e.g., a diagram of a circuit, a phase diagram, etc.), a chemical formula, a term or sentence in a foreign language, a name, a series of dots, a geometric shape, etc. Descriptions of the handwritten input, however, is not limited thereto.

In some implementations, the whiteboard user interface can be of a whiteboard application installed at, or accessible via, the computing device. The whiteboard application can be a standalone app or a web-based app. In some implementations, the computing device includes a touch panel via which the whiteboard user interface is rendered. The handwritten input can be received by the touch panel, for instance, via a finger or a stylus used by user L that touches the touch panel to provide the handwritten input. The computing device, for instance, can be but is not limited to an electronic whiteboard (portable or non-portable).

At block 403, the system processes an image containing the handwritten input, using a trained machine learning model, to generate a model output from which whiteboard content responsive to the handwritten input is determined/generated. For instance, a screenshot of the whiteboard user interface (or a portion thereof that encloses the handwritten input) can be acquired and pre-processed to reduce a background noise from the screenshot and/or to resize the screenshot into the image (containing the handwritten input) that is of a predetermined image size.

In some implementations, in addition to the image containing the handwritten input, a control input and/or a transcription of an audible input received by the computing device in association with the handwritten input can also be processed using the trained machine learning model. In some implementations, the control input can be a user selection of a control (e.g., a selectable GUI element displayed within the whiteboard user interface that identifies or selects a particular type of content (e.g., an image, an introduction, a video, etc.) to be rendered as part of the whiteboard content responsive to the handwritten input. In some implementations, the control input can include a user selection of more than one control (e.g., two or more controls).

In some implementations, the audible input can include audio data corresponding to the handwritten input. For instance, the audible input can include an audible repetition of the handwritten input. In this case, a transcription of the audible input can be utilized by the trained machine learning model to verify whether a recognition of the handwritten input is accurate. As another example, the audible input can include a type of content desired by the user as the whiteboard content to be rendered in response to the handwritten input. The audible input can include a spoken utterance requesting one or more particular types of content (e.g., image and/or a natural language content) to be rendered in response to the handwritten input.

For instance, given that the handwritten input is a math question of “What is the area of a triangle with a base of 10 cm and a height of 5 cm?”, the spoken utterance can be “let's see a solution to the math question”. In this case, the whiteboard content generated using the trained machine learning model can be, “The solution to this math question can be determined using the formula: area=(base*height)/2, in which case, (10*5)/2=25. 25 is the answer to this question.”

As another example, given that the handwritten input is a handwritten word of “house”, the spoken utterance can be “let's see an image of a house and explore different parts of a house”. In this case, the whiteboard content generated using the trained machine learning model can include first content (i.e., an image for a house) of a first type (e.g., image) and second content (e.g., a list of general structures or components of a house, or a plurality of labels for components of the house in the image) of a second type (e.g., natural language). The second type can be different from the first type. The different types of content in the whiteboard content can be rendered at different locations within the whiteboard user interface. Alternatively or additionally, the different types of content in the whiteboard content can be rendered at different points of time within the whiteboard user interface. For instance, the first content (i.e., an image for a house) can be rendered at a first moment, and the second content (e.g., a list of general structures or components of a house) can be rendered at a second moment subsequent to the first moment. The second content can be rendered automatically after a certain period of time has passed since the rendering of the first content. Alternatively, the second content can be rendered manually based on/in response to receiving an additional user input (e.g., a touch input received at the whiteboard user interface, such as a double click at a blank region of the whiteboard user interface).

In some implementations, a type of the whiteboard content can be determined based on a user profile of the user that provides the handwritten input. For example, the user profile can be retrieved from data stored in data storage (e.g., 106 or 126 in FIG. 1A) of the computing device. The user profile can be created for the whiteboard application that provides access to the whiteboard user interface. The user profile can be provided to the trained machine learning model to be processed along with the image that contains the handwritten input, so that the whiteboard content generated by the trained machine learning model can be tailored to the user that has a certain age, education, occupation, etc., as specified in the user profile.

At block 405, the system can cause the whiteboard content to be rendered at the whiteboard user interface with respect to the handwritten input. For example, the whiteboard content can be rendered in a non-overlapping manner with respect to the handwritten input. In some implementations, the whiteboard content and/or the handwritten input can be moved around by the user within the whiteboard user interface. This re-arrangement can save space of the whiteboard user interface for additional handwritten input and/or typed input. In some implementations, the whiteboard content and/or the handwritten input can alternatively be removed/erased from the whiteboard user interface.

Optionally, the whiteboard content can be rendered in a style sufficiently similar to (e.g., at least 80% similarity in font and size) the handwritten input. Optionally, the whiteboard content can include different types of content responsive to the handwritten input, and the different types of content can be individually movable within the whiteboard user interface, or erased from the whiteboard user interface. The size of the whiteboard content and/or the handwritten input can also be modified by the user via a hand touch gesture (e.g., an enlarging gesture). In case the whiteboard content includes different types of content, the size of each type of the different types of content can be configured/modified by the user individually. For instance, a size of the aforementioned first content can be enlarged, and a size of the second content can be reduced.

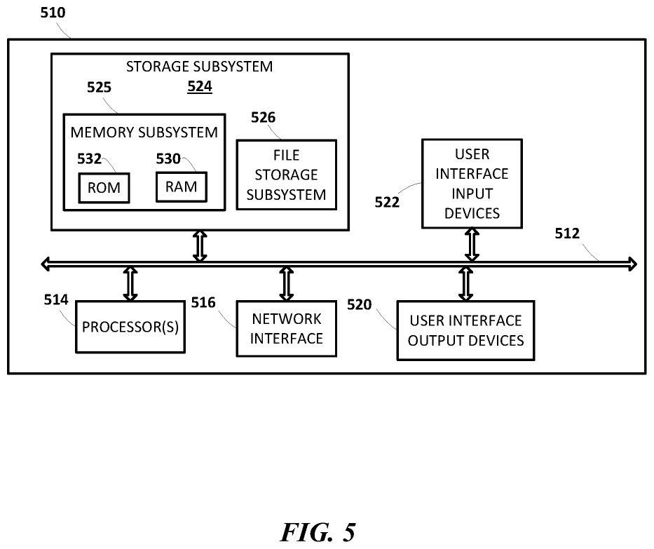

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

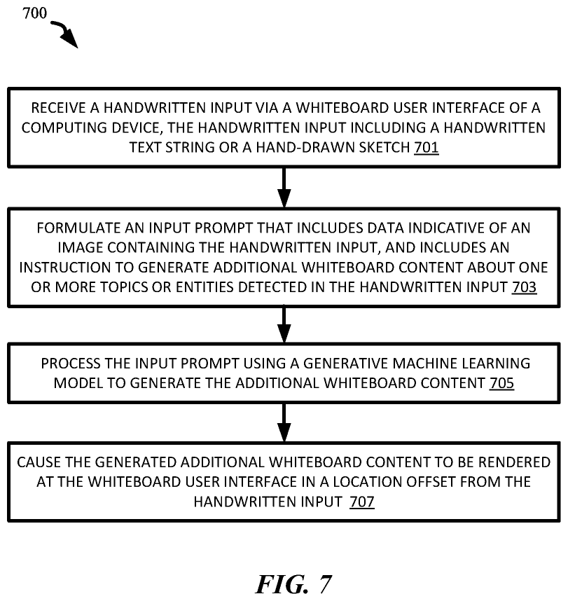

For example, referring to FIG. 7, a flowchart illustrating another example method 700 for generating content responsive to handwritten input is provided. In various implementations, the method 700 can be implemented using a system. The system can include one or more processors, and memory storing instructions that are operable and when executed by the one or more processors, cause the one or more processors to: at block 701, receive a handwritten input via a whiteboard user interface rendered by a computing device, the handwritten input including a handwritten text string or a hand-drawn sketch, where the handwritten input is displayed in real-time at the whiteboard user interface as whiteboard content.

In some of the various implementations, the instructions, when executed by the one or more processors, further cause the one or more processors to: at block 703, formulate/generate an input prompt that includes data indicative of an image containing the handwritten input, as well as an instruction/request to generate additional whiteboard content about one or more topics or entities detected in the handwritten input; at block 705, process the input prompt using a generative machine learning model to generate the additional whiteboard content about one or more topics or entities detected in the handwritten input; and at block 707, cause the additional whiteboard content about one or more topics or entities to be rendered at the whiteboard user interface in a location offset from the handwritten input.

In some of the various implementations, the instructions, when executed by the one or more processors, further cause the one or more processors to: receive a spoken utterance, the spoken utterance being received contemporaneously with the handwritten input; and formulate the input prompt to further include a transcript of the spoken utterance, in addition to including the data indicative of the image that contains the handwritten input and the request to generate the additional whiteboard content.

In some of the various implementations, the instructions, when executed by the one or more processors, further cause the one or more processors to: cause one or more GUI elements to be rendered at the whiteboard user interface, the one or more GUI elements each for including a distinct type of content in the additional whiteboard content; receive a control input that selects a particular GUI element, from the one or more GUI elements, for including a particular type of content in the additional whiteboard content; and formulate the input prompt to further include or identify the control input, in addition to including the data indicative of the image that contains the handwritten input and the request to generate the additional whiteboard content.

In some of the various implementations, the instructions, when executed by the one or more processors, further cause the one or more processors to: retrieve a user profile associated with a registered user account of a whiteboard application that provides access to the whiteboard user interface; and formulate the input prompt to further include the user profile, in addition to including the data indicative of the image that contains the handwritten input and the request to generate the additional whiteboard content.

In some of the various implementations, the generative machine learning model is a transformer-based machine learning model.

In some of the various implementations, the handwritten input is a hand-drawn object, and the additional whiteboard content includes content responsive to a search engine query, wherein the search engine query is formulated based on an object type of the hand-drawn object determined based on a trained machine learning model trained for object classification.

In some of the various implementations, the handwritten input includes a mathematical question, and the additional whiteboard content includes a solution to the mathematical question.

In some of the various implementations, the whiteboard user interface is rendered at an electronic display of the computing device, and wherein the electronic display comprises a touchscreen display.

Optionally, instead of receiving the handwritten input via the whiteboard user interface rendered at the touchscreen display, the handwritten input can be received at a physical surface that is non-electronic (e.g., a blackboard, a wall, a paper, etc.), and a camera can be utilized to capture an image that contains the handwritten input. A projector can be utilized to display the handwritten input and/or aforementioned whiteboard content (sometimes referred to as “additional whiteboard content”) generated using one or more machine learning models (e.g., the whiteboard content generation model 190C). Optionally, the projector (or computing device having the touchscreen display) can be portable.

In some of the various implementations, the input prompt is formulated in response to at least one triggering condition, of a plurality of pre-determined triggering conditions each for triggering generation of the additional whiteboard content, being satisfied.

In some of the various implementations, the at least one triggering condition being no additional handwritten input being received after a predefined duration since receiving the handwritten input, or being receiving a user confirmation that confirms a request to generate the additional whiteboard content.

in various implementations, a method is implemented using one or more processors, where the method includes: receiving a handwritten input via a whiteboard user interface rendered by a computing device, the handwritten input including a handwritten text string or a hand-drawn sketch, where the handwritten input is displayed in real-time at the whiteboard user interface as whiteboard content.

In some of the various implementations, the method further includes: formulating an input prompt to include data indicative of an image containing the handwritten input, as well as an instruction to generate additional whiteboard content about one or more topics or entities detected in the handwritten input; processing the input prompt using a generative machine learning model, to generate the additional whiteboard content about one or more topics or entities detected in the handwritten input; and causing the additional whiteboard content about one or more topics or entities to be rendered at the whiteboard user interface in a location offset from the handwritten input.

In some of the various implementations, the image containing the handwritten input is acquired from the whiteboard user interface.

In some of the various implementations, formulating the input prompt comprises: formulating the input prompt to further include a transcript of a spoken utterance received contemporaneously with the handwritten input, in addition to the data indicative of the image containing the handwritten input and the instruction to generate the additional whiteboard content.

In some of the various implementations, formulating the input prompt comprises: formulating the input prompt to include a control input for including a particular type of content in the additional whiteboard content, in addition to the data indicative of the image containing the handwritten input and the instruction to generate the additional whiteboard content.

In some of the various implementations, formulating the input prompt comprises: formulating the input prompt to further include a user profile associated with a registered user account of a whiteboard application that provides access to the whiteboard user interface, in addition to including the data indicative of the image that contains the handwritten input and the request to generate the additional whiteboard content.

In some of the various implementations, the handwritten input is a hand-drawn object, and the additional whiteboard content includes content responsive to a search engine query, wherein the search engine query is formulated based on an object type of the hand-drawn object determined using a trained machine learning model trained for object classification.

In some of the various implementations, the handwritten input includes a mathematical question, and the additional whiteboard content includes a solution to the mathematical question. In some of the various implementations, the generative machine learning model is a transformer-based machine learning model.

In various implementations, a non-transitory storage medium is provided, where the non-transitory storage medium stores instructions that are operable and when executed by the one or more processors, cause the one or more processors to: receive a handwritten input via a whiteboard user interface rendered by a computing device, the handwritten input including a handwritten text string or a hand-drawn sketch, where the handwritten input is displayed in real-time at the whiteboard user interface as whiteboard content; formulate an input prompt to include at least data indicative of an image containing the handwritten input and an instruction to generate additional whiteboard content about one or more topics or entities detected in the handwritten input; process the input prompt using a generative machine learning model to generate the additional whiteboard content about one or more topics or entities detected in the handwritten input; and cause the additional whiteboard content about one or more topics or entities to be rendered at the whiteboard user interface in a location offset from the handwritten input. As a non-limiting example, the handwritten input is a hand-drawn object, and the whiteboard content includes a natural language description of the hand-drawn object.

What is claimed is:

1. A system, comprising:
one or more processors; and
memory storing instructions that are operable and when executed by the one or more processors, cause the one or more processors to:
receive a handwritten input via a whiteboard user interface rendered by a computing device, the handwritten input including a handwritten text string or a hand-drawn sketch,
wherein the handwritten input is displayed in real-time at the whiteboard user interface as whiteboard content;
formulate an input prompt that includes data indicative of an image containing the handwritten input, as well as a request to generate additional whiteboard content about one or more topics or entities detected in the handwritten input;
process the input prompt using a generative machine learning model to generate the additional whiteboard content about one or more topics or entities detected in the handwritten input; and
cause the additional whiteboard content about one or more topics or entities to be rendered at the whiteboard user interface in a location offset from the handwritten input.

2. The system of claim 1, wherein the instructions further cause the one or more processors to:
receive a spoken utterance, the spoken utterance being received contemporaneously with the handwritten input, and
formulate the input prompt to further include a transcript of the spoken utterance, in addition to including the data indicative of the image that contains the handwritten input and the request to generate the additional whiteboard content.

3. The system of claim 1, wherein the instructions further cause the one or more processors to:
cause one or more GUI elements to be rendered at the whiteboard user interface, the one or more GUI elements each for including a distinct type of content in the additional whiteboard content,
receive a control input that selects a particular GUI element, from the one or more GUI elements, for including a particular type of content in the additional whiteboard content, and
formulate the input prompt to further include the control input, in addition to including the data indicative of the image that contains the handwritten input and the request to generate the additional whiteboard content.

4. The system of claim 1, wherein the instructions further cause the one or more processors to:
retrieve a user profile associated with a registered user account of a whiteboard application that provides access to the whiteboard user interface, and
formulate the input prompt to further include the user profile, in addition to including the data indicative of the image that contains the handwritten input and the request to generate the additional whiteboard content.

5. The system of claim 1, wherein the generative machine learning model is a transformer-based machine learning model.

6. The system of claim 1, wherein the handwritten input is a hand-drawn object, and the additional whiteboard content includes content responsive to a search engine query, wherein the search engine query is formulated based on an object type of the hand-drawn object determined based on a trained machine learning model trained for object classification.

7. The system of claim 1, wherein the handwritten input includes a mathematical question, and the additional whiteboard content includes a solution to the mathematical question.

8. The system of claim 1, wherein the whiteboard user interface is rendered at an electronic display of the computing device, and wherein the electronic display comprises a touchscreen display.

9. The system of claim 1, wherein the input prompt is formulated in response to at least one triggering condition, of a plurality of pre-determined triggering conditions each for triggering generation of the additional whiteboard content, being satisfied.

10. The system of claim 9, wherein the at least one triggering condition being no additional handwritten input being received after a predefined duration since receiving the handwritten input, or being receiving a user confirmation that confirms the request to generate the additional whiteboard content.

11. A method implemented using one or more processors, the method comprising:
receiving a handwritten input via a whiteboard user interface rendered by a computing device, the handwritten input including a handwritten text string or a hand-drawn sketch,
wherein the handwritten input is displayed in real-time at the whiteboard user interface as whiteboard content;
formulating an input prompt to include data indicative of an image containing the handwritten input, as well as a request to generate additional whiteboard content about one or more topics or entities detected in the handwritten input;
processing the input prompt using a generative machine learning model, to generate the additional whiteboard content about one or more topics or entities detected in the handwritten input; and
causing the additional whiteboard content about one or more topics or entities to be rendered at the whiteboard user interface in a location offset from the handwritten input.

12. The method of claim 11, wherein the image containing the handwritten input is acquired from the whiteboard user interface.

13. The method of claim 11, wherein formulating the input prompt comprises:
formulating the input prompt to further include a transcript of a spoken utterance received contemporaneously with the handwritten input, in addition to the data indicative of the image containing the handwritten input and the request to generate the additional whiteboard content.

14. The method of claim 11, wherein formulating the input prompt comprises:
formulating the input prompt to include a control input for including a particular type of content in the additional whiteboard content, in addition to the data indicative of the image containing the handwritten input and the request to generate the additional whiteboard content.

15. The method of claim 11, wherein formulating the input prompt comprises:
formulating the input prompt to further include a user profile associated with a registered user account of a whiteboard application that provides access to the whiteboard user interface, in addition to including the data indicative of the image that contains the handwritten input and the request to generate the additional whiteboard content.

16. The method of claim 11, wherein the handwritten input is a hand-drawn object, and the additional whiteboard content includes content responsive to a search engine query, wherein the search engine query is formulated based on an object type of the hand-drawn object determined using a trained machine learning model trained for object classification.

17. The method of claim 11, wherein the handwritten input includes a mathematical question, and the additional whiteboard content includes a solution to the mathematical question.

18. The method of claim 11, wherein the generative machine learning model is a transformer-based machine learning model.

19. A non-transitory storage medium storing instructions that are operable and when executed by the one or more processors, cause the one or more processors to:
receive a handwritten input via a whiteboard user interface rendered by a computing device, the handwritten input including a handwritten text string or a hand-drawn sketch,
wherein the handwritten input is displayed in real-time at the whiteboard user interface as whiteboard content;
formulate an input prompt to include at least data indicative of an image containing the handwritten input and a request to generate additional whiteboard content about one or more topics or entities detected in the handwritten input;
process the input prompt using a generative machine learning model to generate the additional whiteboard content about one or more topics or entities detected in the handwritten input; and
cause the additional whiteboard content about one or more topics or entities to be rendered at the whiteboard user interface in a location offset from the handwritten input.

20. The non-transitory storage medium of claim 19, wherein the handwritten input is a hand-drawn object, and the whiteboard content includes a natural language description of the hand-drawn object.
